(19) United States
(12) Patent Application Publication
(10) Pub. No.: US 2025/0305635 A1
(43) Pub. Date: Oct. 2, 2025

(54) A HYDROGEN REFUELING STATION WITH A SOLID PHASE COOLING BANK

(71) Applicant: Cavendish Hydrogen A/S, Herning (DK)

(72) Inventor: Marcin Blazniak ANDREASEN, Hovedgård (DK)

(21) Appl. No.: 18/863,376

(22) PCT Filed: May 4, 2023
(86) PCT No.: PCT/DK2023/050111

§ 371 Date: Nov. 6, 2024

(30) Foreign Application Priority Data
May 6, 2022 (DK) PA 2022 70244

(51) Int. Cl. F17C 5/06

(52) U.S. Cl. CPC F17C 5/06; F17C 2221/012; F17C 2227/0341

(57) ABSTRACT

A hydrogen refueling station (1) for filling a vessel (2) of a vehicle (3) with hydrogen from a storage via a dispensing module (5) comprises a cooling system (7) configured to cool the hydrogen flow. The cooling system comprises a primary cooling loop (8) comprising a refrigerant in a liquid phase, a first heat exchanger (9), a compressor (10), a second heat exchanger (11) thermally coupled to the flow of hydrogen, a solid phase tank (13) being connectable to the primary cooling loop via a buffer conduit (15) comprising a buffer valve (16), a controller (17) configured to control a cooling of said hydrogen flow via the second heat exchanger by controlling a flow of the refrigerant in the primary cooling loop and further configured to increase a cooling capacity of the second heat exchanger by controlling a state of the buffer valve.

### FIELD OF THE INVENTION

The present invention relates to a hydrogen refueling station comprising a cooling system configured to cool a flow of hydrogen, and to a method of cooling a flow of hydrogen.

### BACKGROUND OF THE INVENTION

During a fueling of a vessel of vehicle with hydrogen at a hydrogen refueling stations, the temperature of the hydrogen increases as a result of increasing pressure. To avoid overheating the hydrogen, a sufficient cooling system is therefore required to cool the hydrogen. Since the utilization of hydrogen refueling stations fluctuates over time, e.g. during the day, the week or even across month, the cooling system should ideally be able to handle high and low utility periods as well as fueling demands lying in-between the two, in an energy efficient manner. However, cooling systems of hydrogen stations, including e.g. compressors, condensers etc., are typically scaled according to the cooling requirements of the high utility periods, and so the cooling systems operates inefficiently at other levels of utilization, resulting in a high energy consumption.

EP3214355 B1 disclose a cooling system that seeks to cope with high utilization periods by building an ice slurry buffer in the heat exchanger of the system during low utility periods. The ice slurry comprises ice and liquid refrigerant, and the cooling capacity provided by the ice of the slurry is utilized to cool during high utilization periods. However, the presence of ice in the heat exchanger used for heat exchange degrades the heat transfer properties and thereby the efficiency of the cooling system. Moreover, by having a mixture of liquid refrigerant and icy refrigerant in the heat exchanger, the slurry is used for cooling even in low utilization periods of the hydrogen refueling station. Thus, in addition to the mentioned lowering of the heat transfer properties, this configuration also requires additional energy to constantly maintain the ice slurry, e.g. in-between fuelings.

### SUMMARY OF THE INVENTION

The inventors have identified the above-mentioned problems and challenges related to cooling of hydrogen in hydrogen refueling stations, and subsequently made the below-described invention, which may increase cooling capacity of a hydrogen station during e.g. high utility periods, without substantially compromising energy efficiency of the cooling system of the hydrogen station.

The invention relates to a hydrogen refueling station configured to fill a vessel of a vehicle with hydrogen; the hydrogen refueling station comprising: a refueling system comprising: a hydrogen storage; and a dispensing module fluidly connected to said hydrogen storage via a supply conduit and fluidly connectable to said vessel of said vehicle so as to establish a hydrogen flow from said hydrogen storage to said vessel of said vehicle; wherein said hydrogen refueling station further comprises a cooling system configured to cool said hydrogen flow, wherein said cooling system comprises: a primary cooling loop comprising: a refrigerant in a liquid phase, a first heat exchanger; a compressor; and a second heat exchanger thermally coupled to said hydrogen flow; a solid phase tank comprising a refrigerant in a solid phase, and wherein said solid phase tank is fluidly connectable to said primary cooling loop via a buffer conduit comprising a buffer valve; a controller configured to control a cooling of said hydrogen flow via said second heat exchanger by controlling a flow of said refrigerant in said primary cooling loop and further configured to increase a cooling capacity of said second heat exchanger by controlling a state of said buffer valve.

The invention may advantageously provide a cooling system for a hydrogen station with an efficient cooling capacity buffer, e.g. embodied in the form of the solid phase tank. Advantageously, the cooling system utilizes the high thermal energy storage capability of solid phase refrigerant, while at the same time ensuring efficient heat transfer by utilizing the effective heat transfer properties of liquid phase refrigerant for cooling of the hydrogen. For example, by having a cooling bank (cooling capacity buffer) in the form of a solid phase tank comprising refrigerant in a solid phase, the cooling system of the hydrogen refueling station may advantageously provide increased cooling capacity during high demand periods (e.g. fueling demand) without increasing the rounds per minute of the compressor of the cooling system. This advantageously has the further effect that a smaller less energy consuming compressor can be utilized and/or the compressor may be run at lower rounds per minute, in turn reducing the energy consumption of the cooling system, without compromising refueling capacity of the hydrogen refueling station. In other words, the cooling system provides a high utilization degree of the cooling system at a reduced energy consumption.

In particular, the second heat exchanger of the cooling system advantageously exploits the efficient heat transfer properties of liquid phase refrigerant to cool the flow of hydrogen, e.g. during a refueling operation. Meanwhile, the solid phase tank advantageously provides an efficient cooling buffer (cooling bank), which utilizes the much larger thermal energy storage capabilities of refrigerant in a solid phase. Advantageously, solid phase refrigerant may be formed in the solid phase tank during e.g. low demand periods, and in turn provide additional cooling capacity during high demand periods.

Further advantageously, since the primary cooling loop may be fluidly decoupled from the solid phase tank, the primary cooling loop may be applied to cool the hydrogen flow independent of the solid phase tank, during e.g. a refueling. Thereby, the solid phase tank may be saved for situations where the cooling capacity of the primary cooling loop is substantially exhausted. Thereby, the solid phase tank and the solid phase refrigerant is not being constantly used and degraded. This minimizes the energy that would otherwise be required to rebuild the solid phase constantly or at least very often, and thereby the energy consumption required to maintain the solid phase refrigerant in the solid phase tank is minimized.

In some cooling systems, ice is combined with liquid phase refrigerant to form an ice slurry of refrigerant. In such a system, the ice in the ice slurry functions as a cooling buffer. However, the heat transfer capabilities disadvantageously decreases with the amount of present solid phase refrigerant in the slurry, and furthermore it is difficult to control the size of such an ice buffer. Advantageously, the particular configuration of the cooling system of the invention enables the solid phase tank and the primary cooling loop to be fluidly separated. This may facilitate precise control of the amount of solid phase refrigerant that is present in the solid phase tank and of the formation of solid phase refrigerant in the solid phase tank, while at the same time, it may ensure that substantially no solid phase refrigerant is present in the second heat exchanger. Thereby, the efficient heat transfer capabilities of the liquid phase refrigerant in the second heat exchanger is efficiently utilized to cool the hydrogen flow.

Advantageously, the cooling system may comprise a buffer conduit comprising a buffer valve, which may enable fluid to flow between the primary cooling loop and the solid phase tank. Advantageously, controlling the state of the buffer valve enables the pressure in the system to be distributed across both of these systems in a controlled manner. For example, by distribution the pressure among both of these arrangements of the cooling system, e.g. by opening the buffer valve, the pressure in the primary cooling loop may decrease as refrigerant such as, e.g., gaseous refrigerant, flows from the primary cooling loop to the solid phase tank, and thereby advantageously decreases the load on the compressor, in turn increasing the cooling capacity of the cooling system. Notice further that the temperature decreases as the pressure drops in the second heat exchanger when e.g. the buffer valve is opened. Thereby, the solid phase tank comprising solid phase refrigerant may effectively be utilized to increase the cooling capacity of the primary cooling loop including the second heat exchanger, while ensuring that the hydrogen flow is cooled in the second heat exchanger utilizing the liquid refrigerant with high heat transfer capabilities. Thus, advantageously, the buffer valve may be opened during high refueling demand utilization periods of the refueling station, where the load on the cooling system is particularly high. Further notice, that the solid phase bank may thus be utilized to increase cooling capacity of the cooling system, without necessarily providing a thermal heat transfer between solid phase refrigerant and the hydrogen flow.

In essence, the cooling system may thereby provide an efficient means of increasing the cooling capacity based on a solid phase tank comprising solid phase refrigerant, but without necessarily relying on inefficient heat transfer between the solid phase refrigerant and the flow of hydrogen.

To cope with the cooling requirements during high utilization periods of a hydrogen refueling station, traditional cooling systems for hydrogen refueling stations would require a substantial upscaling of many if not all components of the traditional cooling system. While such an upscaling might cope with the cooling demands, it would be very expensive and at the same time, it would render the cooling system inefficient, particularly in low to medium utilization periods. On the contrary, the cooling system of the invention may not necessarily require upscaling of components such as e.g. the compressor, which may remain relatively compact. Yet, the cooling system is capable of handling cooling requirements e.g. during the high utilization periods of the hydrogen refueling station. Thereby, advantageously, the size of the cooling system and hydrogen station of the present invention may remain relatively compact.

In short, the present invention advantageously provides a hydrogen refueling station with a cooling system capable of increasing its cooling capacity during increased utilization demands of the hydrogen refueling station. This, advantageously, may be achieved without increasing the rpm and/or size of the compressor of the cooling system, and thereby the cooling system may be particularly efficient and capable of cooling the flow of hydrogen to an outlet hydrogen temperature that complies with requirements (e.g. safety requirements).

When referring to a hydrogen station or to a hydrogen refueling station, it may for example be a hydrogen station configured to fill a vessel of a vehicle with gaseous hydrogen. Thus, when referring to a hydrogen flow, the flow may be a flow of gaseous hydrogen. Nevertheless, the principles of the cooling system may be utilized to cool hydrogen irrespective of the phase of hydrogen. Thus, in principle the cooling system of the invention could be implemented in hydrogen stations utilizing liquid hydrogen, if such station would require cooling.

When referring to the phase of a substance, e.g. hydrogen or a refrigerant, the phase defines the physical phase of the substance, including e.g. solid, liquid, gaseous. Off note, the mentioned physical phases of a substance may coexist at particular temperature and/or pressure conditions; namely at the triple point of the substance.

In the present disclosure, cooling bank may be understood broadly as a cooling buffer, which may be applied to increase a cooling capacity of e.g. the second heat exchanger. The cooling bank may also be referred to as ice bank or solid phase bank. The cooling bank may include the solid phase tank comprising refrigerant in a solid phase.

Notice that cooling capacity may generally refer to a cooling system's ability to remove heat. It should be understood that the term cooling capacity may in the context of the present disclosure be understood broadly to describe the ability of a system and/or one or more components of a system to remove heat. For example, the cooling capacity of the second heat exchanger may refers to the ability of the second heat exchanger to remove heat. Moreover, a cooling capacity of one component may be applied via other component of the system to remove heat, e.g. from the hydrogen flow. E.g. when referring to a cooling capacity of the solid phase tank, this may be understood as a cooling capacity of the solid phase tank (cooling bank) that may be applied to elevate the cooling capacity via e.g. the second heat exchanger, as described elsewhere in the present disclosure. Thus a cooling capacity of a component may be directly applied to cool e.g. a hydrogen flow, or it may e.g. be indirectly utilized to elevate a cooling capacity of another component of the cooling system.

In the present context, the mentioned state of the buffer valve refers to an open or closing of said valve or to a degree of openness of the valve. Thus, it should be understood that open or closing may also include different degrees of open or closed so as to control the flow through the valve. Thus, the buffer valve may be implemented as an open/close valve or alternatively as a flow control valve.

Depending on the implementation of the invention, different valves could be applied to control the flow of refrigerant in the cooling system and the flow of hydrogen in the refueling system. In some implementations, the valves may be electrically controlled by a controller, whereas in others, one or more valves may be mechanically controlled based on, different parameters, e.g. pressure and temperature, without requiring control signals from a controller. For example, the buffer valve may be implemented as a mechanical valve where the state of the valve depends on e.g. a pressure, a temperature or a third and/or fourth parameter. Other valves of the hydrogen station may be controlled in a similar way, depending on the implementation.

When referring to e.g. a threshold or other parameters having a value, It should be understood that when stating that a value, parameter or the like exceeds or is exceeding a given threshold, it may encompass both exceeding below the given threshold and/or exceeding above the threshold.

The term fluid connection or fluidly connected may be broadly understood as a physical connection along which a fluid may flow. Thus, e.g., components described as being fluidly connected may be connected, e.g., via one or more of the following non-limiting examples, including one or more conduits, pipelines, pipes, hoses, lines, ducts, sewers, canals, channels, vessels, via valves etc. Note that the skilled person may choose to implement a fluid connection means different to those mentioned, depending on the particular implementation of the invention.

According to an embodiment of the invention, said state of said buffer valve is controlled between an open state and a closed state.

Advantageously, this has the effect that it enables control of the flow of refrigerant between the primary cooling loop and the solid phase tank. Thus, for example, refrigerant may flow from the primary cooling loop to the solid phase tank via the buffer conduit, and thereby the pressure and/or temperature may be decreased in, for example, the second heat exchanger, when the buffer valve is in the open state. This may be advantageous during, for example, high fueling demand periods. Advantageously, controlling the valve to be in a closed state at least has the effect of saving the solid phase tank as a buffer for high fueling demand periods.

It should be understood that an open state may refer to that the buffer valve may be opened to enable different sizes of flows to flow through the valve, according to some embodiments of the invention. This has the advantage that the buffer valve may be regulated to maintain a pressure and/or temperature in the second heat exchanger, by controlling the degree of openness of the buffer valve (the state of the buffer valve). Thus, according to an embodiment of the invention, the buffer valve may be a flow control valve.

According to an embodiment of the invention, said second heat exchanger includes a liquid phase tank comprising said refrigerant in a liquid phase.

Advantageously, this has the effect that a cooled refrigerant may be stored in the liquid phase tank and thereby thermal energy can be stored in the liquid during low utility periods of the hydrogen refueling station. The stored thermal energy can then be utilized to cool hydrogen during fueling with the hydrogen station. Furthermore, advantageously, the heat transfer properties of refrigerant in a liquid phase is higher than that of e.g. solid phase refrigerant and thereby utilizing liquid refrigerant for cooling in the second heat exchanger provides efficient thermal energy transfer between the refrigerant and the hydrogen. E.g. convective heat transfer properties of refrigerant in a liquid phase may be utilized. It should be understood that the term liquid phase tank refers to a tank, which may comprise refrigerant, e.g., refrigerant in a liquid phase.

According to an embodiment of the invention a buffer flow of refrigerant to said solid phase tank from said second heat exchanger is established when a primary operation parameter of said primary cooling loop exceeds a primary operation parameter threshold.

Advantageously, this has the effect that when the buffer flow is established, it may decrease a pressure in the second heat exchanger as refrigerant flows to the solid phase tank, and thereby the temperature of the second heat exchanger may decrease and the cooling capacity of the second heat exchanger may increase. Thus, the cooling capacity of the solid phase tank (cooling bank) may be utilized by establishing said flow, which is advantageous. A further advantage is that it may be possible to determine one or more conditions (e.g. primary operation parameter and primary operation parameter threshold) for when a buffer flow should be established. Advantageously, such conditions may be based on the primary operation parameter of the primary cooling loop and thereby the cooling capacity of the solid phase tank (cooling bank) may be utilized according to an actual primary operation of said primary cooling loop, thereby facilitating efficient use of the cooling bank, by determining when to establish the buffer flow.

According to an embodiment of the invention, a buffer flow of refrigerant to said solid phase tank from said second heat exchanger is established via said buffer conduit by opening said buffer valve.

Advantageously, this has the effect that the buffer flow may be efficiently controlled via said buffer valve.

According to an embodiment of the invention, said primary operation parameter is associated with said second heat exchanger.

Advantageously, this has the effect that the buffer flow may be controlled based on a condition (primary operation parameter) of the component of the primary cooling sloop that facilitate the actual heat exchange between refrigerant and the hydrogen flow, which is advantageous.

It should be understood that a primary operation parameter associated with the second heat exchanger, may e.g. also be a parameter related to the refrigerant comprised by the second heat exchanger.

According to an embodiment of the invention, said primary operation parameter threshold comprises a predefined primary temperature and/or a predefined primary pressure, and wherein said primary operation parameter comprises a primary temperature established by a primary temperature sensor comprised by said primary cooling loop and/or comprises a primary pressure established by a primary pressure sensor comprised by said primary cooling loop.

Advantageously, this has the effect that the buffer flow may be established based on temperature and or pressure of the primary cooling loop. Utilizing the temperature and pressure of the primary cooling loop is advantageous, since these parameters correlate with the cooling capacity of the primary cooling loop. Thus, in essence the temperature and/or pressure sensor may advantageously facilitate that the cooling bank of the solid phase tank is only utilized when the cooling capacity of the primary cooling loop exceeds a threshold. E.g. the cooling bank is only utilized by establishment of the buffer flow, when e.g. a temperature and/or pressure of the primary cooling loop is exceed.

It should be understood that the term primary pressure refers to a pressure in the primary cooling loop, while primary temperature refers to the temperature in the primary cooling loop. The terms may thus refer to a temperature and/or pressure of any components comprised by the primary cooling loop, including among the others refrigerant and the second heat exchanger, the compressor, valves etc.

According to an embodiment of the invention, a primary pressure and/or said primary temperature is measured in said second heat exchanger.

Advantageously, this has the further effect of providing pressure and/or temperature measurements of the second heat exchanger. This may advantageously provide information on the cooling capacity of said second heat exchanger, which is correlated with temperature and pressure. Furthermore temperature and/or pressure measurements of the second heat exchanger may advantageously be utilized to regulate the state of various valves comprised by the hydrogen refueling station. E.g. the state of the buffer valve may be regulated based on the pressure and/or temperature measurements. Thereby the buffer flow may e.g. be established based on a temperature and/or a pressure and a given associated primary operation parameter threshold of the second heat exchanger. This is advantageous, since the heat exchange between refrigerant and the hydrogen flow predominantly occurs in the second heat exchanger.

It should be understood that the primary pressure and/or primary temperature of the second heat exchanger may be measured at various locations in the cooling system that may provide measures substantially corresponding to the temperature and pressure, respectively, in the second heat exchanger, including, for example, within the second heat exchanger itself and/or in conduits connected to the second heat exchanger, in additional components and/or vessels connected to the second heat exchanger, in valves.

Based on the above mentioned advantages regarding measuring a primary pressure and/or a primary temperature; according to an embodiment of the invention, said primary cooling loop comprises a temperature sensor configured to measure a primary temperature in said second heat exchanger and/or a pressure sensor configured to measure a primary pressure in said second heat exchanger.

According to an embodiment of the invention, said primary operation parameter threshold includes a temperature between minus 55 degrees Celsius and minus 31 degrees Celsius, such as between minus 52 degrees Celsius and minus 33 degrees Celsius, such as between minus 49 degrees Celsius and minus 35 degrees Celsius, such as between minus 50 degrees Celsius and minus 38 degrees Celsius such as preferably between minus 50 degrees Celsius and minus 40 degrees Celsius, such as preferably a temperature corresponding to a saturation temperature of said refrigerant and/or a temperature above said saturation temperature of said refrigerant.

Advantageously, this has the effect, that the buffer flow may be established based on a temperature (primary operation parameter threshold), and thereby the cooling bank of the solid phase tank may be applied based on temperature, which is advantageous. E.g. when the temperature has risen to a level at which the second heat exchanger may no longer cool the hydrogen flow at a sufficient rate, e.g. without decreasing the hydrogen flow, the buffer flow may e.g. be established to increase the cooling capacity of the primary cooling loop, e.g. of the second heat exchanger, to maintain the hydrogen flow. Thereby, the refueling capacity of the hydrogen refueling station may be maintained since the buffer flow may be established when the temperature in the primary cooling loop exceeds the temperature threshold (primary operation parameter threshold).

According to an embodiment of the invention, said primary operation parameter threshold is a saturation temperature of said refrigerant and/or a temperature above said saturation temperature of said refrigerant.

According to an embodiment of the invention, said primary operation parameter threshold is a saturation pressure of said refrigerant and/or a pressure above said saturation pressure of said refrigerant, wherein said saturation pressure corresponds to a saturation temperature of carbon dioxide, such as a temperature between minus 55 degrees Celsius and minus 31 degrees Celsius, such as between minus 52 degrees Celsius and minus 33 degrees Celsius, such as between minus 49 degrees Celsius and minus 35 degrees Celsius, such as between minus 50 degrees Celsius and minus 38 degrees Celsius such as preferably between minus 50 degrees Celsius and minus 40 degrees Celsius.

Advantageously, this has the effect that the buffer flow may be established based on a saturation temperature and/or a saturation pressure of said refrigerant, and thereby, advantageously, the buffer flow can be established at a point where the evaporation rate of refrigerant in the second heat exchanger becomes large and would otherwise quickly elevate the pressure and temperature in the second heat exchanger and thereby reduce the cooling capacity of the second heat exchanger, if the buffer flow was not established. Thus, establishing the buffer flow at this saturation temperature and/or pressure is advantageous.

It should be understood that because temperature and pressure are correlated, regulation of valves, compressor and other components of the cooling system, which are based on one of these two parameters (e.g. temperature), may in some other embodiments of the invention be based on the other (e.g. pressure), or both of the two parameters. Because the saturation pressure is different between different refrigerants, pressure thresholds, such as e.g. primary operation parameter threshold, may vary for different refrigerants when the threshold is a pressure threshold. To ensure efficient cooling of hydrogen when operation according to a primary pressure, it may therefore be preferred to determine the pressure threshold such that it corresponds to a temperature within the mentioned ranges for said refrigerant. E.g. a primary operation parameter threshold between e.g. minus 55 degrees Celsius and minus 31 degrees Celsius.

According to an embodiment of the invention, said primary operation parameter threshold includes a pressure between 5.4. bar and 9.0 bar, such as between 6.0 bar and 8.5 bar, such as between 6.7 bar and 8.4 bar, such as preferably between 6.8 bar and 8.3 bar, such as preferably a saturation pressure of said refrigerant, wherein said saturation pressure corresponds to a temperature between minus 55 degrees Celsius and minus 31 degrees Celsius.

Advantageously, this has the effect, that the buffer flow may be established based on a pressure (primary operation parameter threshold), and thereby the cooling bank of the solid phase tank may be applied based on pressure, which is advantageous. As pressure in the primary cooling loop, e.g. in the second heat exchanger, rises, the cooling capacity decreases. Thereby, it is advantageous to establish the buffer flow based on pressure, to reduce the pressure in the second heat exchanger and thereby possibly maintain the cooling capacity and thereby the hydrogen flow and in turn the refueling capacity of the hydrogen refueling station. E.g. when the pressure has risen to a level at which the second heat exchanger may no longer cool the hydrogen flow sufficiently, e.g. without decreasing the hydrogen flow, the buffer flow may e.g. be established to increase the cooling capacity of the primary cooling loop, e.g. of the second heat exchanger, to maintain the hydrogen flow. Establishing the buffer flow may diminish the pressure in the second heat exchanger, and thereby, the refueling capacity of the hydrogen refueling station may be maintained since the buffer flow may be established when the pressure in the primary cooling loop exceeds the pressure threshold (primary operation parameter threshold).

E.g. at a pressure of 8.3 bar (corresponding to a temperature of substantially minus 45 degrees Celsius for e.g. carbon dioxide) in the second heat exchanger, the cooling of the hydrogen flow via the second heat exchanger may be significantly diminished. Thus, it may be advantageous to establish the buffer flow at this pressure, or possibly even at lower pressures, to reduce pressure in the second heat exchanger and thereby elevate the cooling capacity of the second heat exchanger.

When referring to a pressure that corresponds to a temperature, it should be understood that pressure and temperature is correlated, and thus a given temperature may correspond to a given pressure and vice versa.

It should be understood that the saturation temperature is the temperature for a corresponding saturation pressure, at which a liquid (e.g. refrigerant) boils into its vapor phase. The liquid (e.g. refrigerant) can be said to be saturated with thermal energy. The saturation pressure is the pressure for a corresponding saturation temperature, at which a liquid (e.g. refrigerant) boils into its vapor phase. The liquid (refrigerant) can be said to be saturated with thermal energy. Advantageously, a primary operation parameter threshold including a pressure that corresponds to a temperature between minus 31 degrees Celsius and minus 55 degrees Celsius, may have the effect of providing cooling of hydrogen, e.g. be able to cool hydrogen to a temperature at or below minus 30 degrees Celsius.

According to an embodiment of the invention, a buffer flow of refrigerant to said solid phase tank from said second heat exchanger is terminated when a buffer operation parameter exceeds a buffer operation parameter threshold of said solid phase tank and/or when said hydrogen flow is terminated and/or when said primary operation parameter threshold does not exceed said primary operation parameter threshold.

Advantageously, this has the effect that the buffer flow is only utilized in conditions where additional cooling is required (e.g. when the primary operation parameter threshold is exceeded), and/or when there is a hydrogen flow to cool with the cooling system, e.g. when a fueling is being carried out by the refueling system, and/or when a buffer operation parameter threshold is not exceeded by the buffer operation parameter threshold. The latter may occur in situations where the cooling capacity of the solid phase tank (cooling bank) is exhausted.

The term buffer operation parameter may be understood as a parameter associated with the operation of the solid phase tank (cooling bank). E.g. the solid phase tank may e.g. be operating in a state where the cooling capacity of the solid phase tank is low, e.g. after extensive and long utilization of the cooling bank, or it may be in an operating state where the cooling capacity of the cooling bank is at a level where it may be utilized, or anything in between. E.g. when the buffer operation parameter exceeds the buffer operation parameter threshold, this may indicate that the cooling capacity of the cooling bank is not at a state where it may be efficiently used for cooling but may need to be rebuild, and thereby at this state the buffer flow of refrigerant may be terminated, which is advantageous.

According to an embodiment of the invention, a buffer buildup flow of refrigerant from said solid phase tank to an inlet of said compressor is established based on a buffer operation parameter of said solid phase tank and further based on a buffer operation parameter threshold, and wherein said buffer buildup flow facilitates establishment of a cooling bank of said refrigerant in a solid phase comprised by said solid phase tank.

Advantageously this has the effect of decreasing the pressure and thereby the temperature in the solid phase tank, and hence facilitating a phase change of refrigerant comprised by the solid phase tank into a solid phase and so, advantageously, a cooling bank of solid phase refrigerant may be established. A further advantage is that the buffer buildup flow may be controlled based on the buffer operation parameter and the buffer operation parameter threshold.

According to an embodiment of the invention, a second heat exchanger outlet valve is arranged at an outlet of said second heat exchanger.

Advantageously, this has the effect that by closing the second heat exchanger outlet valve, while at the same time keeping the buffer valve open, a buffer buildup flow may be established when the compressor is active and thereby refrigerant from the solid phase tank may be removed via the buffer conduit and thereby decrease the pressure and temperature in the solid phase tank and in turn, a cooling bank of solid refrigerant in a solid phase may be established in the solid phase tank.

Thus, more specifically, in an implementation of the invention, a buffer buildup flow may be established from the solid phase tank to the inlet of the compressor by closing the second heat exchanger outlet valve and by opening the buffer valve. This advantageously has the above described effect of facilitating a phase change of the refrigerant in the solid phase tank so that a cooling bank comprising solid phase refrigerant may be established in the solid phase tank. The phase change may be established because of the pressure drop and thereby the temperature drop may arise in the solid phase tank as refrigerant is removed from the solid phase tank.

Advantageously, the cooling bank may subsequently be applied to increase a cooling capacity of the second heat exchanger, e.g. by opening said buffer valve as described elsewhere.

The term arranged at an outlet of the second heat exchanger may refer to any position that enable the second heat exchanger outlet valve to separate a flow of refrigerant from the second heat exchanger from a flow of refrigerant from the solid phase tank via e.g. the buffer conduit.

According to an embodiment of the invention, said solid phase tank (13) is fluidly connected to an inlet of said compressor (10) via a bypass conduit (18) comprising a bypass valve (19), and wherein said bypass conduit (18) is arranged to bypass said second heat exchanger (11).

Advantageously, this has the effect that refrigerant in liquid and/or gaseous phase comprised by the solid phase tank may be transitioned into solid phase (ice), since it enables the compressor to decrease the pressure (and thereby the temperature) in the solid phase tank via the bypass conduit, and thereby the compressor facilitates the phase transition. In other words, the bypass conduit may enable the build and/or rebuild of a refrigerant ice bank in the solid phase tank.

A further advantage is that the rounds per minute of the compressor may be maintained even in no fueling periods where cooling is not required, since the compressor may be used to generate solid phase refrigerant in the solid phase tank instead of being ramped down. An advantageous effect of keeping a substantially constant operation of the compressor is that it may prolong the lifespan of the compressor. Furthermore, it may also decrease the overall energy consumption of the cooling system, since it diminishes the number of times the compressor needs to be ramped down and then up again, which is a relatively energy consuming process. Thus, notice here that starting a compressor requires a lot of energy, and that this may be avoided by the cooling system of the invention, which may facilitate keeping the compressor on and utilizing it for building up the cooling bank in the solid phase tank.

According to an embodiment of the invention, a buffer buildup flow of refrigerant from said solid phase tank to an inlet of said compressor is established via a bypass conduit arranged to bypass said buffer conduit, and wherein said buffer buildup flow is established by opening a bypass valve comprised by said bypass conduit.

Advantageously, this has the effect that the valves required to establish the buffer flow may be controlled based on a received buffer operation parameter, and thereby the valves does not require complex operation via e.g. a controller.

According to an embodiment of the invention, the bypass valve may be a mechanical check valve and/or one way valve.

This advantageously enable the valve to be regulated based on a buffer operation parameter, and thereby the valve does not need to be connected to a controller to be regulated.

According to an embodiment of the invention, said buffer operation parameter threshold comprises a predefined buffer temperature and/or predefined buffer pressure, and wherein said buffer operation parameter comprises a buffer temperature established by a buffer temperature sensor configured to measure a temperature of said solid phase tank and/or comprises a buffer pressure established by a pressure sensor configured to measure a pressure of said solid phase tank.

Advantageously, this has the effect that e.g. the buffer buildup flow may be controlled according to temperature and/or pressure, and thereby the buffer build up flow may e.g. be established when temperature and/or pressure exceeds a threshold. E.g. when a temperature and/or a pressure in the buffer tank is high and reestablishment of the cooling bank e.g. by establishment of the buffer buildup flow may be required.

Advantageously, this has the further effect of providing pressure and/or temperature measurements. The measurements may, for example, be utilized by a controller to monitor the state of the cooling bank comprised by the solid phase tank and so provide information of the current cooling capacity of the solid cooling bank. The measurement may further, e.g. be used to ensure safe operation of the hydrogen refueling station, which is advantageous.

I should be understood that measuring a temperature of said solid phase tank may refer to measuring the temperature of the refrigerant comprised by the solid phase tank. Alternatively it may also refer to measuring the temperature of the solid phase tank itself, or in some implementations it may even refer to measuring a temperature in conduits directly connected to the solid phase tank and/or alternatively in the valves of these conduits.

It should further be understood that measuring the pressure of the solid phase tank, may refer to measuring a pressure inside the tank. Alternatively, the pressure may be measured in the conduits fluidly coupled to the solid phase tank and or in valves of these conduits.

Based on the above mentioned advantages associated with measuring a buffer pressure and/or a buffer temperature; according to an embodiment of the invention, said solid phase tank comprises a temperature sensor configured to measure a buffer temperature in said solid phase tank and/or comprises a pressure sensor configured to measure a buffer pressure in said solid phase tank.

According to an embodiment of the invention, said buffer operation parameter threshold includes a temperature between minus 60 degrees Celsius and minus 30 degrees Celsius, such as between minus 57 degrees Celsius and minus 33 degrees Celsius, such as between minus 56 degrees Celsius and minus 40 degrees Celsius, such as between minus 57 degrees Celsius and minus 38 degrees Celsius such as between minus 56.54 degrees Celsius and minus 50 degrees Celsius, such as preferably above minus 56.56 degrees Celsius, such as more preferably above a temperature corresponding to a triple point of said refrigerant.

Advantageously, this has the effect that the buffer buildup flow may be established based on a temperature (buffer operation parameter threshold), and thereby the buildup of the cooling bank of the solid phase tank may be based on temperature, which is advantageous. E.g. when the temperature has risen to a level at which the cooling bank may no longer provide efficient cooling, e.g. via the second heat exchanger, the buffer buildup flow may e.g. be established to rebuild the cooling bank and thereby the cooling capacity of the cooling bank.

When the temperature (and pressure) rises above the triple point of the refrigerant, the refrigerant changes from a solid phase into a liquid phase. Thus, to keep the refrigerant in a solid phase in the solid phase tank, the temperature (and pressure) should preferably be maintained at or below the triple point of the refrigerant. Thus, the buffer operation parameter threshold may most preferably be determined as a temperature and/or pressure corresponding to the triple point of the refrigerant or a temperature and/or pressure close to the triple point of the utilized refrigerant. Different refrigerants has different triple points, and thereby the optimal buffer operation parameter threshold may vary depending on the utilized refrigerant. Thus, it should be understood that it may be advantageous to set the buffer operation parameter threshold within a range of the triple point of the utilized refrigerant, e.g. at a temperature and/or pressure value below and/or above the triple point of the utilized refrigerant. E.g. to ensure earlier establishment of the buffer buildup flow, a lower temperature and/or pressure may be utilized as buffer operation parameter threshold. If it is preferred to delay the establishment of the buffer buildup flow (slower response), a higher temperature and/or pressure may be utilized as buffer operation parameter threshold. Thus, it should be understood that the buffer operation parameter threshold may be determined within a range of temperature and/or pressure, depending on the implementation of the invention.

Thus, according to an embodiment of the invention, the buffer operation parameter threshold may include a temperature within 0 percent and 15 percent of a triple point of said refrigerant, such as within 0 percent and 10 percent of a triple point of said refrigerant, such as within 0 percent and 5 percent of said refrigerant, such as within 0 percent and 4 percent of said triple point of said refrigerant.

According to an embodiment of the invention, said buffer operation parameter threshold includes a pressure between 5.1. bar and 8.0 bar, such as between 5.2. bar and 8.0 bar, such as between 5.2 bar and 7.2 bar, such as between 5.2 bar and 6 bar, such as preferably above 5.2 bar, such as more preferably a pressure corresponding to a triple point of said refrigerant and/or to a pressure above a triple point of said refrigerant.

Advantageously, this has the effect, that the buffer buildup flow may be established based on a pressure (buffer operation parameter threshold), and thereby the cooling bank of the solid phase tank may be established or rebuild based on pressure, which is advantageous. A pressure increase the solid phase tank may indicate that the cooling capacity of the cooling bank comprised by the solid phase tank is decreased. Thereby, it may be advantageous to rebuild the cooling bank by establishing the buffer buildup flow based on pressure.

E.g. when the pressure in the solid phase tank is above a refrigerant triple point, the solid phase refrigerant may start to melt. Thus, it may be advantageous to establish the buffer buildup flow at a pressure above triple point, to maintain sufficient cooling capacity of the cooling bank.

E.g. in embodiments utilizing e.g. a refrigerant such as carbon dioxide; at pressures in the solid phase tank above 5.2 bar, the cooling capacity of the cooling bank may be significantly reduced and the solid phase refrigerant may start to melt. Thus, in such embodiment, it may be advantageous to establish the buffer buildup flow at a pressure above 5.2 bar or higher in the solid phase tank, to maintain sufficient cooling capacity of the cooling bank.

According to an embodiment of the invention, the buffer buildup flow is terminated when a pressure and/or temperature in said solid phase tank reaches and/or falls below a tiple point of said refrigerant and/or when a pressure and/or temperature in said solid phase tank falls 0 percent to 15 percent below a triple point of said refrigerant, such as falls 0 percent to 10 percent below said triple point of said refrigerant, such as falls 0 percent to 5 percent below said triple point of said refrigerant, such as falls 0 percent to 2 percent below said triple point of said refrigerant.

Advantageously, this has the effect that the buffer flow is terminated when at least a substantial portion of refrigerant comprised by the solid phase tank has been transformed into solid phase. The further below the triple point of the refrigerant that the temperature and/or pressure reaches in the solid phase tank before the buffer buildup flow is terminated, the more solid phase refrigerant may be generated in the solid phase tank before the buffer flow is terminated. Nevertheless, failing to terminate the buffer buildup flow may result in high energy consumption of the cooling system. Thereby, it may be preferred in some embodiments to terminate the buffer buildup flow earlier, e.g. when the temperature and/or pressure in the solid phase tank falls 0 percent to 5 percent below the triple point of the refrigerant.

According to an embodiment of the invention, in a no fueling state of said hydrogen refueling station the controller controls an operation pressure in said solid phase tank to be lower than an operation pressure in said second heat exchanger, by controlling a buffer buildup flow and by controlling said compressor.

Advantageously, this has the effect that during a subsequent refueling operation following the no fueling state, the solid phase tank can be used as a pressure buffer, which may be utilized to reduce pressure and thereby temperature in the second heat exchanger by establishing a fluid connection form the second heat exchanger to the solid phase tank. Thereby, advantageously, the cooling capacity of the second heat exchanger may be increased.

In the present context, operation pressure of the solid phase tank should be understood as a pressure that is maintained in the solid phase tank during a no fueling situation. It should be understood that this pressure may increase when e.g. the buffer valve is opened, and/or decrease if the solid phase tank is connected to an inlet of the compressor of the primary cooling loop.

An operation pressure of the second heat exchanger refers to a pressure that is maintained in the second heat exchanger at a no fueling situation. The pressure may increase as the load on the primary cooling loop increases. The operation pressure of the second heat exchanger may e.g. decrease when the buffer valve is opened and refrigerant flows toward the solid phase tank operated at a lower operation pressure.

The term no fueling state refer to a situation where the hydrogen refueling station is not fueling.

According to an embodiment of the invention, an operation pressure and/or an operation temperature, respectively, of said solid phase tank corresponds to a triple point of said refrigerant and/or to a pressure and/or temperature below said pressure and/or temperature corresponding to a triple point of said refrigerant.

Advantageously, this has the effect that the refrigerant in the solid phase tank is in a solid phase (ice).

According to an embodiment of the invention, an operation pressure of said solid phase tank is substantially between minus 4.8 bar and 7.1 bar, such as substantially between minus 5 bar and 6.8 bar, such as substantially between 5.1 bar and 6.3, such as substantially between 5.1 bar and 5.5 bar such as preferably substantially below 5.2 bar, such as more preferably substantially below a pressure corresponding to a triple point of said refrigerant.

According to an embodiment of the invention, an operation temperature of said solid phase tank is substantially between minus 60 degrees Celsius and minus 30 degrees Celsius, such as substantially between minus 57 degrees Celsius and minus 45 degrees Celsius, such as below minus 54 degrees Celsius, such as substantially below minus 56 degrees Celsius, such as preferably below a temperature corresponding to a triple point of said refrigerant.

Advantageously, this has the effect that the refrigerant comprised by the solid phase tank may be maintained in a solid phase so that it can be used for cooling, e.g. during peak periods.

It should be understood that a triple point of a substance such as a refrigerant is characterized by having a triple point where the refrigerant may exist as a solid, liquid and in a gaseous phase. The triple point is characterized by temperature and pressure. At temperatures and pressures below the triple point, the refrigerant is in a solid phase. Advantageously, by using an operation pressure and/or operation temperature of said solid phase tank below a triple point of a refrigerant may therefore enable the refrigerant to be maintained in a solid phase and thereby a cooling bank comprising solid phase refrigerant may be maintained in the solid phase tank.

According to an embodiment of the invention, said refrigerant in a liquid phase and said refrigerant in a solid phase is substantially the same substance.

Advantageously, this has the effect that when refrigerant form the solid phase tank is mixed with refrigerant from the primary cooling loop, the chemical composition of the fluid circulating the cooling system may be kept substantially constant, and thereby the properties, including e.g. the melting point and the triple point of the refrigerant, does not change. Thereby, control the cooling capacity of the cooling bank of the solid phase tank and the cooling capacity of the second heat exchanger may be controlled accurately and hence, the efficiency of the cooling system may be optimized.

According to an embodiment of the invention, said refrigerant in a liquid phase and said refrigerant in a solid phase is carbon dioxide.

Advantageously, this has the effect that carbon dioxide may be utilized for cooling in a liquid phase at a temperature that efficiently cools the hydrogen flow during a fueling, while at the same time carbon dioxide may be utilized as a solid phase cooling bank in the solid phase tank, since the triple point of carbon dioxide is approximately between minus 56 degrees Celsius and minus 57 degrees Celsius at approximately 5.2 bar, such as more precisely the triple point of carbon dioxide is 5.18 bar, and thereby the cooling bank may be efficiently established without requiring a large energy consumption. Further notice that the here mentioned temperatures are advantageous for cooling a hydrogen flow for refueling, since this flow may e.g. advantageously be cooled to a temperature below minus 30 degrees Celsius to avoid reducing the hydrogen flow during a refueling of a vehicle. Notice that using a liquid phase refrigerant for the cooling is advantageous, since the heat transfer in the liquid phase is much larger than in the solid phase. E.g. because of the convective heat transfer capabilities of a liquid phase refrigerant.

It should be understood that other refrigerant having similar properties to carbon dioxide may also be utilized by the cooling system. When using such other refrigerants, the solid phase tank may be operated at a temperature and/or pressure corresponding to the triple point or below the triple point of the specific refrigerant used.

According to an embodiment of the invention, said cooling system comprises a buffer filling conduit with a buffer filling valve, wherein said buffer filling conduit is fluidly connecting an outlet of said compressor with said solid phase tank.

Advantageously, this has the effect that the solid phase tank may be filled with refrigerant from the primary cooling loop. This may be advantageous in e.g. some embodiments of the invention where melted and e.g. condensed refrigerant may be collected from the solid phase tank by the primary cooling loop, e.g. by the second heat exchanger and so, the collected refrigerant may be returned to the solid phase tank via the buffer filling conduit.

According to an embodiment of the invention, said solid phase tank is fluidly connected to said second heat exchanger via a drainage conduit comprising a drainage valve.

Advantageously, this has the effect that condensed and melted refrigerant from the solid phase tank may be collected by the second heat exchanger via the drainage conduit. The collected refrigerant may then be reused for cooling in the primary cooling loop, which is advantageous. Furthermore, the drainage valve may advantageously be closed to ensure that the pressure decreases in the solid phase tank during establishment of solid phase refrigerant, e.g. when the buffer buildup flow is established.

According to an embodiment of the invention, said drainage conduit is coupled to said solid phase tank via an outlet positioned in the lower portion of a wall of said solid phase tank and/or in the floor of said solid phase tank.

Advantageously, this has the effect that a flow of refrigerant to the drainage conduit may be facilitated by the center of gravity, and thereby minimizing or eliminating the need for active establishing of the flow, e.g. using a pump or a compressor.

According to an embodiment of the invention, said drainage conduit comprises a receiver vessel and a receiver vessel outlet valve positioned downstream said receiver vessel, and wherein said receiver vessel is positioned downstream said drainage valve.

Advantageously, this has the effect that the receiver vessel may collect refrigerant form the solid phase tank. Typically, the pressure in the solid phase tank may be lower than the pressure in the second heat exchanger, and hence, the pressure may in some embodiments of the invention hinder the refrigerant from flowing from the solid phase tank to the second heat exchanger, e.g., for reusage in the primary cooling loop. Advantageously, the receiver vessel outlet valve may be closed while the drainage valve is open, and thereby the receiver vessel may collect the refrigerant from the solid phase tank. Further advantageously, the receiver vessel outlet valve may subsequently be opened while the drainage valve is closed and as pressure levels equalizes between the second heat exchanger and the receiver vessel, the refrigerant collected by the receiver vessel is emptied into the second heat exchanger, which is advantageous.

According to an implementation of the invention, said buffer conduit may be fluidly connected to said solid phase tank at an upper buffer inlet arranged at the upper portion of said solid phase tank.

Advantageously, this has the effect that it ensures that the inlet may not be blocked by e.g. condensed refrigerant, which could otherwise potentially be the case in some embodiments of the invention, where the buffer inlet may be positioned at the bottom of the solid phase tank.

According to an embodiment of the invention, said solid state tank is arranged at a higher position than said second heat exchanger, with respect to the ground.

Advantageously, this has the effect that refrigerant from the solid phase tank may flow out of the solid phase tank via the drainage conduit due to the force of gravity. This advantageously reduces energy consumption, since a pump or compressor may not be required to remove e.g. condensed and/or melted refrigerant.

According to an embodiment of the invention, said solid phase tank comprises: a solid phase compartment at least partly filled with solid phase refrigerant, and a fluid passage compartment; wherein said fluid passage compartment comprises an inlet fluidly connected to said buffer conduit, and wherein said solid phase compartment comprises an inlet connected to an outlet of said compressor and wherein said solid phase compartment and said fluid passage compartment is at least thermally connected.

Advantageously, this has the effect that when a buffer flow is established via said buffer conduit, the fluid passage compartment may provide a space in which the buffer flow may be received. Thereby blockage of the inlet connected to the buffer conduit by solid phase refrigerant may be avoided, while the thermal connection between the compartments may facilitate cooling of received buffer flow from the primary cooling loop with the solid phase refrigerant of the solid phase compartment. Further advantageously, the outlet from the solid phase compartment to the compressor inlet may be utilized to form solid phase refrigerant in the solid phase compartment via a decrease in pressure achieved when the compressor is activated and removes refrigerant from the solid phase compartment.

According to an embodiment of the invention, said fluid passage compartment comprises a plurality of condensation structures having an exterior portion at least partly enclosed by solid phase refrigerant, and an interior portion configured to receive refrigerant from said buffer conduit.

This is advantageous in that it provides an increased surface area of solid phase refrigerant in the solid phase tank for heat exchange, which may essentially provide improved heat transfer from a received buffer flow to the solid phase refrigerant and thereby it may improve the cooling (and condensation) of the buffer flow received by the solid phase tank.

According to an embodiment of the invention, said solid phase tank comprises a coil conduit fluidly connecting an interior of said solid phase tank with said buffer conduit so as to facilitate exhaustion of refrigerant into said solid phase tank at a level above said refrigerant in a solid phase comprised by said solid phase tank, and wherein said coil conduit is at least partly enclosed by said solid phase refrigerant comprised by said solid phase tank.

Advantageously, this has the effect that refrigerant entering the coil conduit from the buffer conduit is cooled (and condensed) by the solid phase refrigerant of the solid phase tank before the refrigerant is exhausted into the solid phase tank. Advantageously, this provides additional cooling of the gaseous/liquid refrigerant entering the coil conduit from the second heat exchanger, e.g. because the coil conduit may provide a relatively large area of interface between the coil conduit and the refrigerant comprised by the solid phase tank. It should be understood that the coil conduit may sometimes be referred to as a coil.

In an embodiment of the invention, the coil conduit extends from a lower portion of said solid phase tank towards an upper portion of said solid phase tank.

According to an embodiment of the invention, said cooling system comprises a dehumidification conduit fluidly connecting an outlet of said compressor with said coil conduit.

Advantageously, this has the effect that the coil conduit can be used to transfer refrigerant from the compressor outlet to the tank fluid passage, and thereby remove any refrigerant present in the coil conduit, which could otherwise transform into solid phase and thereby block the coil conduit.

According to an embodiment of the invention, said cooling system comprises a condensate boiler fluidly connected to said coil conduit and to said primary cooling loop, and wherein said condensate boiler comprises a boiler.

Advantageously, this has the effect that condensate from the solid phase tank may be collected by the condensate boiler and thereby ensuring that the condensate does not transition into solid phase, and thereby potentially create a block in the coil conduit. Advantageously, the condensate collected in the condensate vessel may be removed by activating the boiler. It should be understood that the condensate boiler may be a vessel, and thereby the condensate boiler may be configured to collect e.g. condensed refrigerant.

According to an embodiment of the invention, said supply conduit comprises a hydrogen cooling loop comprising a hydrogen cooling loop inlet valve and a hydrogen cooling loop outlet valve, and wherein a portion of said cooling loop is thermally coupled to said solid phase tank.

Advantageously, this has the effect that a portion of the hydrogen flow may flow via the hydrogen cooling loop to be cooled by via the thermal connection between the cooling loop and the solid phase tank. This may be particularly advantageous, when the second heat exchanger may not be able to cool the hydrogen flow to a required level. It should be understood that a portion of the hydrogen flow may be any portion of the hydrogen that flows in the supply conduit. All hydrogen flow may thus be guided by the hydrogen cooling loop inlet valve to the hydrogen cooling loop, or a minor portion of the hydrogen flow may be guided through the cooling loop, depending on e.g. cooling demand, based on hydrogen outlet temperature and/or pressure and/or based on pressure and/or temperature measured in other parts of the cooling system.

According to an embodiment of the invention, said solid phase tank comprises level measuring means for measuring a refrigerant level in said solid phase tank (13).

When referring to means of measuring a refrigerant level, such means may be any means of measuring a refrigerants level, including e.g. a continuous float level transmitter, a differential pressure transmitter, a load cell that measures a mass, a radar level transmitter, a radio frequency capacitive level transmitter, an ultrasonic level transmitter etc. Furthermore, the fluid level may also be measured by a ruler or a similar relatively simple and cheap measuring device.

In an implementation of the invention, the measuring means may preferably be configured to measure a refrigerant level of solid phase refrigerant in the solid phase tank. Advantageously, this has the effect of providing a measure of the size of the cooling bank of solid phase refrigerant. The size of the colling bank may advantageously be applied to regulate the amount of solid phase refrigerant in the solid phase tank, e.g. by establishing a flow of refrigerant form the second heat exchanger to the solid phase tank and vice versa. E.g. when the refrigerant level is below a certain level, refrigerant may be supplied to the solid phase tank from the primary cooling loop, e.g., via the buffer filling conduit.

It should be understood that a fluid level may refer to a level of a fluid in any phase, including gaseous, liquid and solid phase.

According to an embodiment of the invention, said liquid phase tank may comprise a level measuring means, configured for measuring a level of refrigerant in said liquid phase tank. Advantageously, this has the effect that the amount of refrigerant comprised by the liquid phase tank may be monitored, and thereby the refrigerant may be redistributed to the liquid phase tank when e.g. the level of refrigerant in the liquid phase tank is below a level threshold.

According to an embodiment of the invention, said level measuring means is configured to measure a level of refrigerant in a solid phase, comprised by said solid phase tank.

Advantageously, this has the effect that the size of solid phase cooling bank may be monitored.

According to an embodiment of the invention, a fluid level in the solid phase tank is regulated based on a refrigerant level threshold.

This is advantageous in that it has the effect that when the fluid level diverges substantially from the fluid level threshold, a fluid connection may be established between said second heat exchanger and said solid phase tank, and advantageously, refrigerant may be distributed among the second heat exchanger and the solid phase tank via said fluid connection based on said fluid level threshold. Thereby, e.g., when the solid phase refrigerant melts and e.g. leaves the solid phase tank, e.g. during utilization of the solid phase tank for increasing the cooling capacity of the second heat exchanger, refrigerant from the second heat exchanger may be supplied to solid phase tank, to maintain the fluid level threshold. Similarly, in embodiments of the invention, the second heat exchanger may be filled with refrigerant form the solid phase tank, via the fluid connection, if required.

The invention further relates to a method of cooling a hydrogen flow of a refueling system of a hydrogen refueling station, wherein said hydrogen refueling station comprises a cooling system comprising: a primary cooling loop comprising a refrigerant; a first heat exchanger, a compressor, and a second heat exchanger thermally coupled to said hydrogen flow comprised by said refueling system; and a solid phase tank comprising said refrigerant; wherein said method comprises the steps of: establishing a cooling bank comprising refrigerant in a solid phase by facilitating a phase change of said refrigerant comprised by said solid phase tank into solid phase refrigerant; establishing said hydrogen flow from a hydrogen storage of said refueling system to a vessel of a vehicle via a dispensing module of said refueling system; cooling said hydrogen flow via said second heat exchanger by circulating said refrigerant within said primary cooling loop by activating said compressor; establishing a buffer flow of refrigerant from said primary cooling loop to said solid phase tank via a buffer conduit when a buffer condition is established, to increase a cooling capacity of said second heat exchanger.

The method of the invention may have similar and/or identical advantages as the advantages described in relation to the above disclosures of the apparatus of the invention, namely the hydrogen refueling station and the cooling system. For example, the method may advantageously cool a hydrogen flow, by utilizing efficient heat transfer properties of liquid phase refrigerant, while at the time, when a buffer condition is established, utilizing the high thermal energy storage capability of solid phase refrigerant of a solid phase tank to increase cooling capacity, which is advantageous. For example, the method may advantageously increase cooling capacity, e.g. during high demand periods (e.g. according to the buffer condition) without increasing the rounds per minute of the compressor. This advantageously has the further effect that a smaller less energy consuming compressor may be utilized and/or the compressor may be run at lower rounds per minute, in turn reducing the energy consumption of the cooling system, without compromising refueling capacity of the hydrogen refueling station.

According to an embodiment of the invention, said buffer condition is established when a primary operation parameter of said primary cooling loop exceeds a primary operation parameter threshold.

This is advantageous in that it may enable the establishment of the buffer flow to be based on conditions associate with the primary cooling loop (primary operation parameter and primary operation parameter threshold) that is utilized for cooling the hydrogen flow. Thus, the cooling bank of the solid phase tank may be applied according to the conditions, e.g. of the primary cooling loop, which is advantageous, as this may provide a way of controlling when the solid phase tank should be applied to increase the cooling capacity of the second heat exchanger.

According to an embodiment of the invention, said step of establishing a cooling bank comprises establishing a buffer buildup flow of refrigerant from said solid phase tank to an inlet of said compressor based on a buffer operation parameter of said solid phase tank and further based on a buffer operation parameter threshold, and wherein said buffer buildup flow facilitates establishment of said cooling bank comprised by said solid phase tank.

This is advantageous in that it has the effect of facilitating the buildup of solid phase refrigerant in the solid phase tank, by reducing pressure in the solid phase tank via the buffer buildup flow. A further advantage is that the buildup of the cooling bank may be initiated based on the buffer operation parameter and buffer operation parameter threshold, and thereby it may be determined when to establish the cooling bank e.g. by controlling these parameters.

It should be understood that in the present context, the term buffer operation parameter refers to one or more parameters associated with the cooling bank, including the solid phase tank and hereto connected conduits including valves of these conduits.

As mentioned previously, these parameters may in some embodiments of the invention e.g. comprise temperature measurements and/or pressure measurements.

According to an embodiment of the invention, said method carried out by said hydrogen refueling station.

According to an embodiment of the invention, the buffer conduit is connected to the solid phase tank below the level of solid phase refrigerant contained in the solid phase tank. Advantageously, the gaseous refrigerant may flow from the second heat exchanger via the buffer conduit and directly into the solid phase refrigerant. This may advantageously facilitate a large contact surface between the gaseous refrigerant and the solid phase refrigerant. Moreover, this may advantageously increase the cooling efficiency and/or the condensation of the cooling system. E.g., making the cooling of the gaseous refrigerant with the solid face refrigerant a faster process, which is advantageous.

Advantageously, carbon-di-oxide may be used as a solid phase refrigerant. Advantageously, this has the effect of providing a porous solid phase refrigerant. This is advantageous in that it prevent clogging conduits connected to the solid phase tank comprising the solid phase refrigerant. Also, the porous structure of the solid phase refrigerant may provide a large contact area between the solid phase refrigerant and the gaseous and/or liquid refrigerant entering the solid phase tank, e.g., via the buffer conduit. This is advantageous in that it may increase the cooling efficiency of the cooling system. E.g., it may provide quicker cooling and/or condensation of the refrigerant entering the solid phase tank via the buffer conduit, which is advantageous.

According to an embodiment of the invention, the buffer conduit is connected to a lower portion of said solid phase tank.

It should be understood that the term lower portion may include the bottom of the solid phase tank. The lower portion of the tank may also be understood to comprise the lower portion of the sides of the solid phase tank.

According to an embodiment of the invention, the bottom portion of the solid phase tank includes the lower 90 percent of the solid phase tank, such as the lower 70 percent of the solid phase tank, such as the lower 50 percent of the solid phase tank, such as the lower 40 percent of the solid phase tank, such as the lower 30 of the solid phase tank, such as the lower 20 percent of the solid phase tank.

The invention further relates to a hydrogen refueling station, wherein said hydrogen station is configured to cool said hydrogen flow according to the method of cooling a hydrogen flow of a refueling system of a hydrogen refueling station of the invention.

The drawings

Various embodiments of the invention will in the following be described with reference to the drawings where

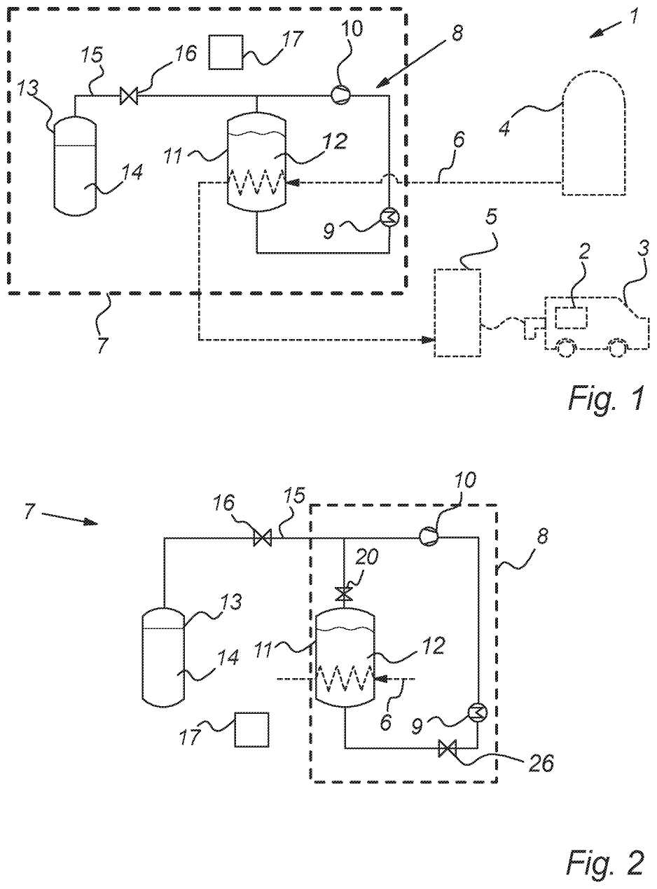

FIG. 1 illustrates a schematic view of a hydrogen station with a cooling system according to an embodiment of the invention,

FIG. 2 illustrates a schematic view of a cooling system with a second heat exchanger outlet valve according to an embodiment of the invention,

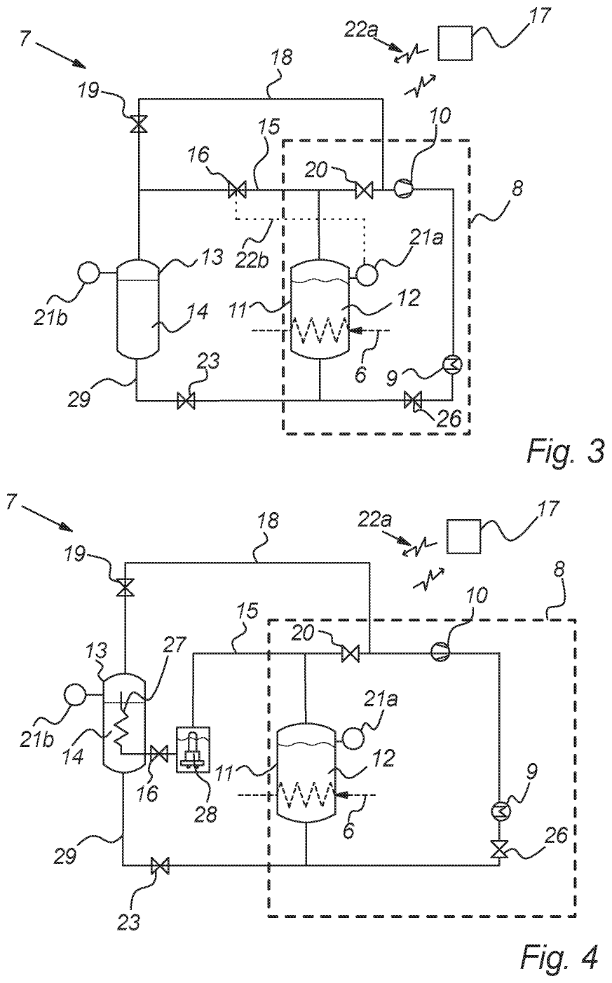

FIG. 3 illustrates schematic view of a cooling system with a bypass conduit and a buffer filling conduit according to an embodiment of the invention,

FIG. 4 illustrates a schematic view of a cooling system with a condensate boiler and a solid phase tank comprising a coil according to an embodiment of the invention,

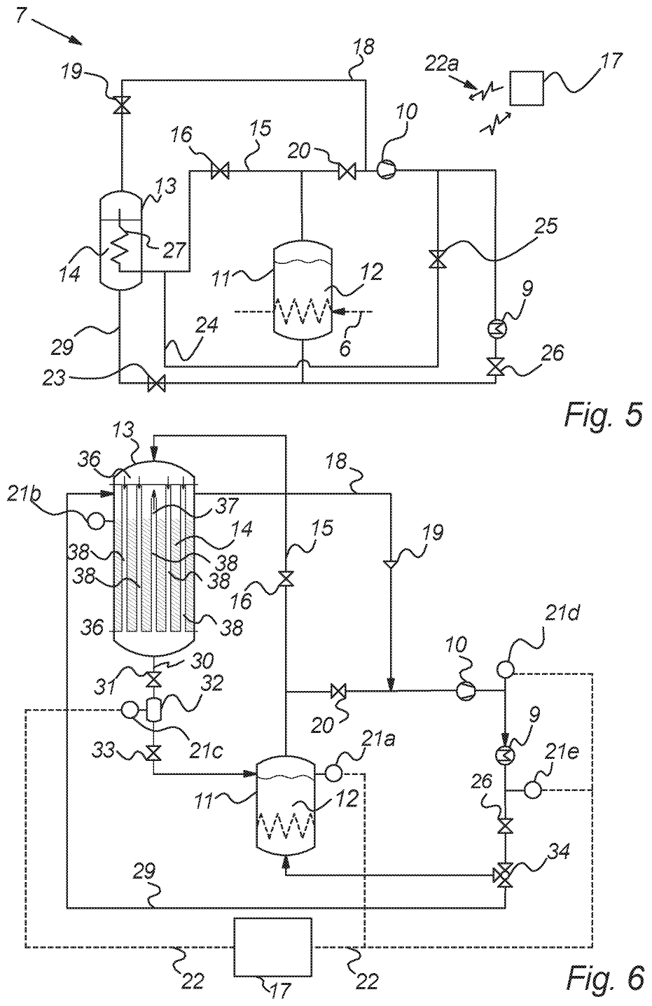

FIG. 5 illustrates a schematic view of a cooling system with a dehumidification boil off conduit according to an embodiment of the invention,

FIG. 6 illustrates a schematic view of a cooling system with a receiver vessel and a compartmentalized solid phase tank according to an embodiment of the invention,

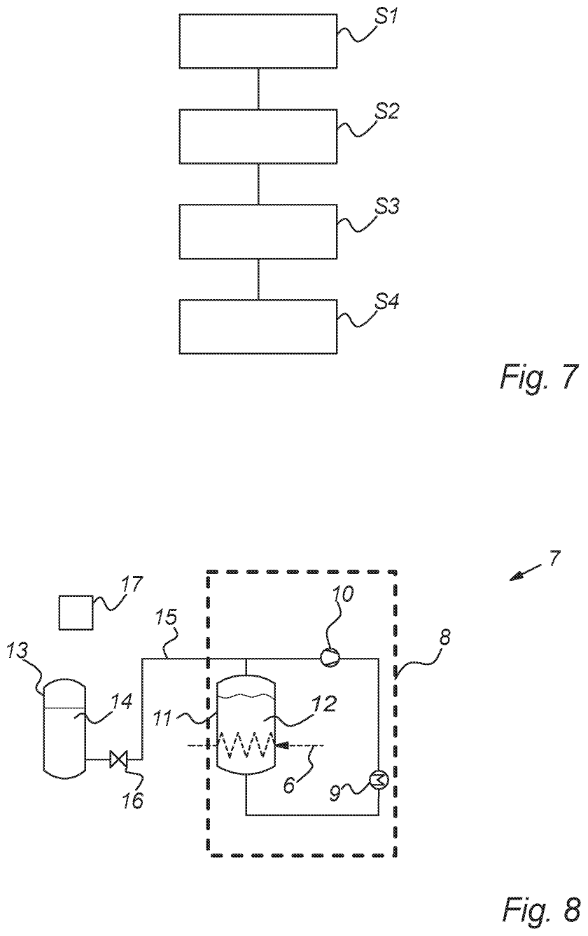

FIG. 7 illustrates method steps according to an embodiment of the invention,

FIG. 8 illustrates a schematic view of a cooling system with a buffer conduit fluidly connected to a lower portion of a solid phase tank according to an embodiment of the invention,

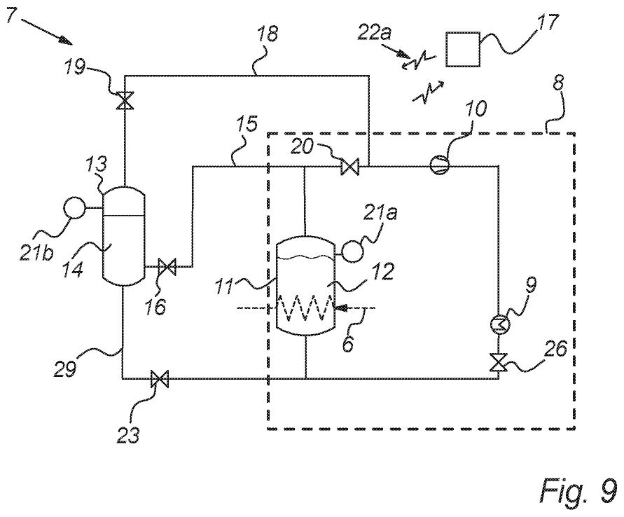

FIG. 9 illustrates a schematic view of a cooling system with a bypass conduit, a buffer filling conduit and with a buffer conduit fluidly connected to a lower portion of a solid phase tank according to an embodiment of the invention.

Note that similar elements on the figures may be referred to with similar wording even if these are not specified with a reference number on all figures.

### DETAILED DESCRIPTION

The following section comprises a detailed description of the invention with reference to the figures.

The description comprises nonlimiting examples of embodiments of the invention. Details such as a specific method and system structures are provided to give an understanding of embodiments of the invention. Note that detailed descriptions of well-known systems, devices, circuits, conduits, some control leads, etc. and methods have been omitted so as to not obscure the description of the invention with unnecessary details. It should be understood that the invention is not limited to the particular examples described below, and that a person skilled in the art may choose to implement the invention in other embodiments without these specific details. Furthermore, it should be understood that the skilled person may choose to combine features of the described embodiments and of the illustrated embodiments of the invention. As such, the invention may be designed and altered in a multitude of varieties within the scope of the invention, as specified in the claims.

It should be understood that the implementation of the cooling system of the invention is not limited to any particular examples of hydrogen refueling stations as given in the following sections. Also notice that the cooling system may be enclosed in standard enclosures of hydrogen stations including e.g. different station modules. Alternatively, the cooling system may also be enclosed separately from the main components and enclosures of the refueling system, including the dispenser, the hydrogen storage and the station module comprising e.g. the compressor of the refueling system.

The present invention relates to a hydrogen refueling station comprising a cooling system, the main purpose of which is to supply hydrogen at an adequate temperature, to a receiving vessel of a vehicle, from a hydrogen supply in the form of a supply network, external hydrogen storage, internal hydrogen storage or a temporary hydrogen storage.

To regulate the hydrogen pressure, temperature, flow, time etc. to comply with currents standards such as e.g., the SAE J2601 standard for refueling of a light duty fuel cell vehicle with hydrogen, the hydrogen refueling station comprises a refueling system and a cooling system, a hydrogen storage and a dispensing module having a nozzle connectable (at least indirectly) to a receiving vessel. Further, the refueling station may comprise compressors, monitor systems, filters, valves, electric components, etc. A hydrogen refueling station according to the present invention may also fill receiving vessels according to other standards or protocols. This is especially true if the receiving vessel is of a heavy-duty vehicle, train, ship, airplane, etc. Hence, filling a receiving vessel or a tank of a vehicle should not limit the invention to only filling a tank of a fuel cell light duty vehicle such as a car or a motorcycle. The cooling system of the hydrogen refueling station comprises at least a primary cooling loop comprising a first heat exchanger, a second heat exchanger and a compressor, and wherein the primary cooling loop may be connected to a solid phase tank comprising solid phase refrigerant.

In general, during a fueling, the temperature of hydrogen supplied to a receiving vessel may increase, e.g. due to a rise in pressure as the receiving vessel is filled. If the refueling rate is elevated, the temperature increases proportionally, and it may be necessary to reduce the refueling rate to avoid overheating of the hydrogen. This disadvantageously increases the time it takes to refuel a vehicle. Thus, to maintain a high fueling rate without risking overheating of the hydrogen, which is a flammable fluid, a cooling system is required to cool the hydrogen. Typically, the hydrogen that leaves the cooling system may e.g. preferably be cooled to a temperature below minus 30 degrees Celsius, to ensure that the refueling rate can be maintained. However, the hydrogen may well also be cooled to even colder temperatures, or alternatively, in some implementations be cooled to temperatures above minus 30 degrees Celsius. Notice, that when the fueling demand is high and the utility of a refueling station is high, the cooling capacity of a cooling system can be challenged if the cooling system is not dimensioned according to the high utility periods. On the other hand, a traditional cooling system dimensioned according to such high peak cooling demand periods, can be expensive to use during less than peak periods, due to e.g. a high energy consumption, given that such system would typically comprise a larger compressor, larger heat exchangers and condensers etc.

The hydrogen refueling station may in some implementations comprise one or more controllers configured to control the refueling system and/or the cooling system of the hydrogen refueling station. However, in other implementations, a single controller may be configured to control both the refueling system and the cooling system. The one or more controllers may according to different implementations of the invention control components such as, e.g., valves and compressors of the hydrogen station via wired connections to the components and/or via wireless connection. The controllers may further be configured to receive input from components such as e.g. valves, sensors etc. of the hydrogen refueling station via wire and/or wirelessly.

In some embodiments of the cooling system, some of the valves may be mechanically controlled valves controlled based on e.g. operation parameters including e.g. primary operation parameter of buffer operation parameters comprising e.g. temperature, pressure, flow etc. from one or more locations in the cooling system. Thereby, the control of valves can be simplified, since these valves may not necessarily need to be controlled by a controller.

FIG. 1 illustrates a schematic view of a hydrogen refueling station 1 according to an embodiment of the invention.

The hydrogen refueling station 1 comprises a refueling system and a cooling system 7. During a fueling operation, the refueling system supplies hydrogen to a vessel 2 of a vehicle 3 by establishing a hydrogen flow from the hydrogen storage 4 via a supply conduit 6 connecting the hydrogen storage 4 to the dispensing module 5, which is connected to the vessel 2 of the vehicle 3. The cooling system 7 is arranged to cool the hydrogen flow established by the refueling system during the fueling operation. The cooling system 7 comprises a primary cooling loop 8 and a solid phase tank 13 comprising refrigerant in a solid phase 14, which is connected via a buffer conduit 15 comprising a buffer valve 16. Thereby, the primary cooling loop 8 and the solid phase tank 13 can be separated by controlling the state of the buffer valve 16 to a closed state. In this implementation, the state of the buffer valve is electrically controlled by the controller 17. However, in other implementations of the invention, the buffer valve 16 could be a mechanically controlled pressure and/or temperature regulated valve.

In this particular example, the hydrogen flow established by the refueling system of the hydrogen refueling station 1 is a flow of gaseous hydrogen. When a fueling of the vehicle 3 is initiated, the gaseous hydrogen flows to the vessel 2 of the vehicle 3. The vessel 2 of the vehicle 3 is connected to a nozzle (not shown) of the dispensing module 5 of the refueling system. In an initial first cooling operation, the buffer valve 16 is in a closed state where the valve is closed, and thereby the solid phase refrigerant 14 comprised by the solid phase tank 13 is fluidly isolated from refrigerant comprised by the primary cooling loop 8. Thereby, when the buffer valve 16 is closed, the cooling of the hydrogen flow is based solely on the primary cooling loop 8 of the cooling system 7.

When the fueling is initiated, the compressor 10 of a primary cooling loop is activated by the controller 17 and thereby refrigerant starts circulating in the primary cooling loop 8. The primary cooling loop 8 further comprises a first heat exchanger 9 connected to the outlet of the compressor 10, a second heat exchanger 11 connected to the outlet of the first heat exchanger 9 and further connected to the inlet of the compressor 10. In the first heat exchanger 9, thermal energy is dissipated from the refrigerant, and thereby, the refrigerant is cooled before it enters the second heat exchanger 11. The second heat exchanger 11 is thermally coupled to the hydrogen flow delivered from the hydrogen storage 4 via the supply conduit 6 during a fueling operation, and thereby, the hydrogen flow is cooled in the second heat exchanger 11.

The second heat exchanger 11 could in principle include any cooling means suitable for cooling a fluid, including gaseous hydrogen. Thus, it should be understood that the second heat exchanger 11 could include any heat exchangers suitable for cooling a fluid. Nonlimiting examples of heat exchangers include for example different plate heat exchangers, gasket plate heat exchangers, shell and tube heat exchanger, tube and tube heat exchangers, finned tube heat exchangers etc. Similar to the second heat exchange 11, different types of heat exchangers could be utilized as the first heat exchanger 9, although the first heat exchanger is configured to cool the refrigerant and not the hydrogen. To add an additional example to the list of already mentioned nonlimiting examples of heat exchangers, the first heat exchanger 9 could be a condenser.

In this example, the second heat exchanger 11 functions as an evaporator that comprises refrigerant in a liquid phase 12. The pressure and thereby the temperature in the second heat exchanger 11 is kept low by the compressor 10, which when activated, continuously removes e.g. vaporized refrigerant. The low pressure in the second heat exchanger 11 facilitates the evaporation process of the refrigerant, which by evaporation efficiently absorbs the heat from the hydrogen flow that is thermally connected to the refrigerant via the second heat exchanger 11, and thereby the hydrogen is cooled. In this example, the refrigerant is carbon dioxide. The temperature (operation temperature) of the carbon dioxide comprised by the second heat exchanger 11 may be approximately −50 degrees at the beginning of the fueling process. Optionally, in this embodiment, the temperature of the refrigerant measured in the second heat exchanger may be understood as a primary operation parameter associated with the second heat exchanger.

To maintain the cooling capacity of the second heat exchanger, e.g. during a fueling, the heat absorbed by the refrigerant in the second heat exchanger 11 must be dissipated from the cooling system 7. To achieve this, the heated and typically vaporized refrigerant of the second heat exchanger is removed from the second heat exchanger 11 by the compressor 10. The refrigerant is then compressed by the compressor 10 as it enters the first heat exchanger 9. The increase in pressure caused by the compressor 10 condenses the refrigerant in the first heat exchanger 9, and thereby the heat absorbed by the refrigerant is transferred from the condensed refrigerant to the surroundings via the first heat exchanger 9, since the temperature of the refrigerant increases beyond the temperature of the surroundings, due to the rise in pressure established by the compressor 10. The cooled refrigerant then leaves the first heat exchanger 9 to return to the second heat exchanger 11.

In addition to the primary cooling loop 8, the cooling system further comprises the mentioned solid phase tank 13 comprising refrigerant in a solid phase 14. Thus, the solid phase tank and solid phase refrigerant essentially constitutes a cooling bank. As mentioned, the solid phase tank 13 is connected to the primary cooling loop 8 via a buffer conduit 15 comprising a buffer valve 16. The state of the buffer valve 16 and the compressor 10, e.g. the rounds per minute (RPM) of the compressor 10, is both controlled by the controller 17, in this exemplified embodiment.

During the fueling operation of the vehicle, the refueling system of the hydrogen refueling station 1 first establishes a hydrogen flow from the hydrogen storage to the vessel 2 of the vehicle 3, via the supply conduit and the dispensing module 5. Meanwhile, the buffer valve 16 is kept in a closed state by the controller, and so, liquid refrigerant 12 is circulated in the primary cooling loop 8 by means of the compressor 10, as described above. Thereby, heat is dissipated from the liquid refrigerant in the first heat exchanger, in turn keeping the refrigerant cool. Thus, as the hydrogen flow passes the second heat exchanger 11, it is cooled via the thermal coupling to the liquid refrigerant 12, before being delivered to the vessel 2 of the vehicle 3.

In this example, a second vehicle (not shown) starts fueling from the hydrogen refueling station 1. Thereby, the hydrogen flow that needs to be cooled is elevated, and thus more heat is transferred from the hydrogen flow to the liquid refrigerant of the primary cooling loop 8 via the thermal coupling to the second heat exchanger. This cause the temperature of the refrigerant circulating in the primary cooling loop to increases and thereby the cooling rate of the second heat exchanger gradually decreases, when the cooling capacity of the primary cooling loop becomes exhausted. At the same time, the pressure in the second heat exchanger 11 increases as more and more refrigerant vaporizes, following the rise in temperature. In this example, this occurs as a second vehicle (not shown) starts fueling, however, depending on the capacity of the fueling system, this may occur at different degrees of utilization of the hydrogen refueling station.

To cool the additional hydrogen supplied to the second vehicle and at the same time avoid reducing the refueling rate (the hydrogen flow) to take a load of the primary cooling loop, the cooling capacity of the solid phase tank 13 is utilized in a second cooling operation.

In the second cooling operation, the controller 17 controls the buffer valve 16 from an initial closed state to an open state. This establishes a buffer flow of refrigerant from the primary cooling loop 8 to the solid phase tank 13, via the buffer conduit 15. In particular, as refrigerant leaves the second heat exchanger 11 via the buffer conduit 15, the pressure and thereby the temperature reduces in the second heat exchanger 11, essentially elevating the cooling capacity of the second heat exchanger 11. Thereby both hydrogen to the first and the second vehicle is effectively cooled by the second heat exchanger 11. Thus the second cooling operation advantageously utilizes both the advantageous heat transfer capabilities of the liquid refrigerant comprised by the second heat exchanger, and the cooling capacity provided by the solid phase refrigerant 14 comprised by the solid phase tank 13.

Optionally, in this exemplified embodiment of the invention, the solid phase tank has a lower operation pressure and a lower operation temperature than the second heat exchanger. The difference in these two operation parameters advantageously makes it possible to decrease the pressure and temperature in the second heat exchanger by opening the buffer valve 16, and thereby increase the cooling capacity of the second heat exchanger 11. In this particular example, the operation temperature and pressure of the solid phase tank is approximately minus 56.5 degrees Celsius and 5.2 bar before the buffer valve is opened, respectively. The operation temperature and pressure of the second heat exchanger 11 is minus 50 degrees Celsius and 6.8 bar before the refueling is initiated, respectively. Thus, according to an embodiment of the invention, the operation pressure and/or operation temperature in the solid phase tank is lower than the operation pressure in the second heat exchanger. Thus, the two mentioned parts of the cooling systems operates at a difference in these operation parameters. In this example, the operation pressure difference between the solid phase tank and the second heat exchanger is 1.6.

The compressor 10 operates more efficiently at a higher suction pressure. This may be realized by an increase in the COP (coefficient of performance) of the system increases. The COP may e.g. be calculated as the ratio of the heat output from a heat exchanger (e.g. a condenser) and the energy consumption of the compressor. In other words, COP describes the relationship between the heat that is dissipated from the system (e.g. via the first heat exchanger), and the energy that is supplied to the compressor. Thus, the COP may change according to temperature and pressure of the second heat exchanger and of the solid phase tank (when the buffer valve is open). Advantageously, the COP of the cooling system with the cooling bank may thereby be relatively high due to the relatively high operation pressure of the second heat exchanger (e.g. 6.8 bar) and given that an energy efficient and relatively smaller compressor may be applied compared with traditional cooling systems. On the other hand, traditional cooling systems would need to be scaled according to expected peak cooling demands, and thereby such systems would require a larger compressor consuming more energy, and thereby the COP of a traditional system is comparatively lower. In a similar way, the COSP (coefficient of system performance) can be calculated to describe the energy supply to the cooling system in relation to the total cooling provided by the cooling system.

Optionally, the second heat exchanger may comprise a tank configured to hold refrigerant in a liquid state. This may increase the cooling capacity of the primary cooling loop.

Optionally, the operation parameter of said solid phase tank may be the same as the buffer operation parameter.

Optionally the operation parameter of said second heat exchanger may be the primary operation parameter.

Optionally, the operation pressure of the solid phase tank may be the buffer pressure.

Optionally, the operation temperature of the second heat exchanger may be the primary operation temperature.

FIG. 2 illustrates a schematic view of a cooling system 7, according to a further embodiment of the invention. The cooling system can be considered a variation of the exemplified cooling system illustrated in FIG. 1. However, the cooling system illustrated in FIG. 2 further comprises a second heat exchanger outlet valve 20 and an expansion valve 26, and a portion of the cooling system is illustrated as a primary cooling loop 8. Hence, similar to the embodiment illustrated in FIG. 1, the cooling system of illustrated in FIG. 2 is configured to cool a flow of hydrogen that flow via a supply conduit 6. The hydrogen flow in the supply conduit 6 may be supplied from a hydrogen storage (not illustrated) and the conduit may e.g. supply a dispensing module (not illustrated) of a hydrogen refueling station. Thereby, the cooling system of FIG. 2 may provide capabilities similar to those of the embodied cooling system of FIG. 1. The following describes additional features and advantages of the embodiment of the invention illustrated in FIG. 2.

In addition to the embodiment of the invention illustrated in FIG. 1, the exemplified cooling system of FIG. 2 comprises the abovementioned expansion valve 26. The expansion valve 26 is arranged between the first heat exchanger 9 and the second heat exchanger 11. By this arrangement, a pressure difference between the first heat exchanger 9 and the second heat exchanger 11 is maintained and/or established, in turn, enabling the second heat exchanger 11 to operate at a lower pressure (primary operation pressure) and lower temperature (primary operation temperature), compared to the first heat exchanger 9. Heat absorbed from the flow of hydrogen in the second heat exchanger 11 can then be dissipated from the primary cooling loop via the first heat exchanger 9. Do notice, that in other embodiments and implementations of the invention, a different position of the expansion valve may be preferred. The expansion valve can be said to divide the primary cooling loop 8 into a high-pressure portion upstream the expansion valve 26 and a low-pressure portion downstream the expansion valve 26. This is achieved by configuring the expansion valve to limit the flow of refrigerant through the valve, so as to maintain the pressure difference between the upstream and the downstream side of the valve. The skilled person within the technical field of the invention would appreciate that the flow through the valve may be regulated in various ways and to various levels of flows depending on e.g. the other components of the cooling system, and/or also based on e.g. temperatures and/or pressures measured in different parts of the cooling system. In this example, the valve is regulated so that the rate at which refrigerant passes through it is the same as the evaporation rate of the second heat exchanger 11. In other optional embodiments, the expansion valve could be controlled differently, depending on the implementation of the cooling system. The valve may, e.g. be controlled by the controller 17.

The cooling system of FIG. 2 further comprises the previously mentioned second heat exchanger outlet valve 20, which enables establishment of a cooling bank of solid phase refrigerant 14 comprised by the solid phase tank 13. The cooling bank is established based on a buffer operation parameter and based on a buffer operation parameter threshold. In particular, the cooling bank is established by closing the second heat exchanger outlet valve 20, opening the buffer valve 16, and activating the compressor 10. This establishes a buffer buildup flow from the solid phase to the inlet of the compressor 10. In this exemplified embodiment, the buffer buildup flow is thereby established via the buffer conduit 15. The buffer buildup flow causes the pressure in the solid phase tank 13 to decreases as refrigerant is pumped out of the solid phase tank 13 by the compressor 10, and thereby the temperature decreases proportionally in the solid phase tank 13. In turn, this causes a phase shift of the refrigerant in the solid phase tank 13 from liquid or gaseous phase into refrigerant in a solid phase 14 in the tank, thereby establishing the cooling bank of solid phase refrigerant 14. After the cooling bank has been utilized for elevating the cooling capacity of the second heat exchanger 11, by keeping valves 20 and 16 open, it may be reestablished by closing the valve 20 and opening the buffer valve 16 and having the compressor 10 running. The control of the valves and the timing of the reestablishment of the cooling bank is controlled by the controller 17, and such that the cooling bank is reestablished during a no fueling period, where the refueling system is not utilized for refueling a vehicle.

To utilize the cooling bank of the solid phase tank 13, both the buffer valve 16 and the second heat exchanger outlet valve 20 is opened (open state) by the controller in a second cooling operation. This establishes a buffer flow of refrigerant from the second heat exchanger 11 to the solid phase tank 13. In this embodiment, the valves are regulated by the controller, which is configured to open the two valves, 16 and 20, based on a primary operation parameter and an associated primary operation parameter threshold.

In this example, the primary operation parameter threshold is a predefined primary pressure of 6.8 bar. In other embodiments of the invention the primary operation parameter threshold may comprise a predefined primary temperature. Thus, initially in a first cooling operation, the hydrogen flowing through the supply conduit 6 is cooled based on the primary cooling loop. During this first cooling operation, the buffer valve 16 is closed, the second heat exchanger outlet valve 20 is opened and the compressor is active. At some point, the cooling capacity of the primary loop is exhausted, and the primary pressure in the second heat exchanger 11 exceeds the primary operation parameter threshold (predefined primary pressure) of 6.8 bar. This initiates a second cooling operation, wherein the compressor 17 opens the buffer valve 16 as the primary operation threshold is exceeded. In this second cooling operation the second heat exchanger outlet valve 20 is kept open and the controller further keeps the compressor 10 running. As described in relation to the embodiment illustrated in FIG. 1, the solid phase tank is operated at a lower pressure than the second heat exchanger, and thereby refrigerant flows from the second heat exchanger to the solid phase tank via the buffer conduit 15 as the buffer valve 16 is opened. As this occur, the primary pressure in the second heat exchanger drops, and thereby the temperature in the second heat exchanger 11 (in some embodiments this may be referred to as primary temperature) decreases proportionally, advantageously increasing the cooling capacity of the second heat exchanger 11. The second cooling operation advantageously may ensure that the flow of hydrogen in the supply conduit 6 can be cooled sufficiently via the second heat exchanger, e.g., to a temperature below minus 30 degrees Celsius. Thereby the flow of hydrogen may be maintained, and thereby the fueling rate of the hydrogen refueling station (not shown) can be maintained in such peak utilization period of the hydrogen refueling station.

In this exemplified embodiment of the invention, a third cooling operation takes over, when the refueling is terminated and the ice bank (cooling bank) needs to be reestablished in the solid phase tank, as described above. In this third cooling operation, the controller closes the second heat exchanger outlet valve, while keeping the buffer valve open, to enable a flow of refrigerant from the solid phase tank to the compressor inlet. This decreases pressure (buffer pressure) and thereby the temperature (buffer temperature) in the solid phase tank, and thereby it facilitates a phase change of the refrigerant remaining in the solid phase tank 13 into a solid phase, and so the cooling bank is reestablished.

Optionally, reestablishing the cooling bank may include maintaining the flow of refrigerant from the solid phase tank 13 to the compressor inlet by having the compressor 10 active, until a buffer pressure and/or buffer temperature of the solid phase tank 13 exceeds a buffer operation parameter threshold. In this exemplified embodiment, the buffer operation parameter threshold is a predefined buffer temperature of minus 56.5 degrees Celsius, which substantially corresponds to the triple point of carbon dioxide, which is utilized as refrigerant. In other implementations of the invention, the buffer operation parameter threshold may be an even lower temperature or it may be a slightly warmer temperature. Notice that the buffer operation parameter threshold may depend on which type of refrigerant that is utilized in the cooling system, since different refrigerant have different melting points, and thereby require different temperature and pressure conditions to exist in a solid phase. Thus, in further embodiments of the invention, the buffer operation parameter threshold may correspond to the triple point of the refrigerant used in such embodiments or be set a value within a percentage range of the triple point of the refrigerant used in the embodiment of the invention.

Optionally, upon reestablishment of the cooling bank, the controller closes the buffer valve and opens the second heat exchanger outlet valve 20, while keeping the compressor running. This causes refrigerant to circulate in the primary cooling loop and thereby refrigerant in the primary cooling loop is cooled. The controller continues this cooling operation until an operation temperature and/or operation pressure is established in the second heat exchanger 11.

Optionally, the operation temperature and/or operation pressure of the second heat exchanger is a temperature and/or pressure value, respectively, below the primary operation parameter threshold. In this embodiment, the cooling operation may be continued until the pressure in the second heat exchanger falls below the primary operation parameter threshold, which in this particular embodiment is minus 50 degrees Celsius.

FIG. 3 illustrates schematic view of a cooling system with a bypass conduit and a buffer filling conduit, according to an embodiment of the invention.

The cooling system illustrated in FIG. 3 can be considered a variation of the embodiments described in relation to FIG. 1 and FIG. 2, and essentially serves the same purpose as these previously described embodiments; namely, to cool a hydrogen flow during a refueling of a vessel of a vehicle. In addition to the embodiments described in relation to FIG. 1 and FIG. 2, the further exemplified cooling system of the invention illustrated in FIG. 3 comprises a bypass conduit 18 with a bypass valve 19, a buffer filling conduit 29 with a buffer filling valve 23 and sensors 21a, 21b, of which one is configured to measure a primary operation parameter (21a) and one is configured to measure a buffer operation parameter (21b), respectively. Furthermore, a data communication link 22a illustrates communication between the controller and the sensors 21a, 21b, and various components controlled by the controller, such as valves and the compressor. The data communication can be wired or wireless and may utilize various suitable communication protocols. In this embodiment, the data communication link 22a represents wired connections. The bypass conduit 18 enables establishment of a fluid connection between the solid phase tank 13 and the inlet of the compressor 10, and at the same time, it bypasses the outlet of the second heat exchanger 11 and the second heat exchanger outlet valve. The bypass valve is controlled by the controller 17. The buffer filling conduit 29 establishes a fluid connection between the outlet of the first heat exchanger 9, the inlet of the second heat exchanger 9, and the lower portion of the solid phase tank 19. The flow of refrigerant to and from the solid phase tank 13 via the buffer filling conduit 29 is regulated by the buffer filling valve 23. The sensor 21a is configured to measure a primary operation parameter, which in this embodiment is the pressure (primary pressure) sin the second heat exchanger, while the sensor 21b is configured to measures a buffer operation parameter, which in this embodiment is the pressure (buffer pressure) in the solid phase tank. The sensors thereby provide pressure measurements to the controller, which utilizes the pressure measurements to control the state of the valves 20, 26, 23, 19 and the compressor 10. The expansion valve 26 is regulated to maintain a subcooling of the refrigerant after the first heat exchanger. Generally, the expansion valve 26 may be operated according to standard practice for operation of expansion valves in cooling systems, as know by the skilled person (see the description of FIG. 1 for an example). The compressor is regulated based on the primary pressure measured with the sensor 21a in the second heat exchangers. When the pressure increases, the rpm of the compressor is increased and vice versa.

When the cooling system is in standby no fueling is performed (no fueling situation) via the refueling system (not shown) of the hydrogen refueling station (not shown), and the cooling bank of solid phase refrigerant 14 in the solid phase tank 13 has been established so that it complies with a buffer operation parameter threshold. In this exemplified embodiment, the buffer operation parameter threshold is a buffer pressure of 5.2 bar (corresponding to approximately minus 56.5 degrees Celsius), which means that the pressure (buffer pressure) in the solid phase tank is substantially 5.2 bar. During standby, the compressor 10 can be inactive.

When a fueling starts and hydrogen is flowing in the supply conduit 6 and passes the second heat exchanger 11 to be cooled, the compressor is activated, the second heat exchanger outlet valve 20 is opened, while the buffer filling valve 23, the bypass valve 19 and the buffer valve 16 is closed. In this configuration, refrigerant is circulated in the primary cooling loop 8 and thereby the temperature of the liquid refrigerant 12 comprised by the second heat exchanger 11 is maintained by the controller 17 at an operation temperature of approximately minus 50 degrees Celsius. This is achieved by controlling the rpm of the compressor 10 and by regulating the expansion valve 26 so that the measured primary pressure (the primary operation parameter) complies with the operation pressure of the second heat exchanger, which in this embodiment is 6.2 bar (corresponding to approximately minus 50 degrees Celsius). The primary operation parameter, may optionally comprise additional pressure measurements measured by pressure sensors upstream and/or downstream the expansion valve 26, and the primary pressure may be based on such other/additional pressure sensors.

Optionally, the primary operation parameter may be a temperature (primary temperature) measured by a sensor configured to measure a temperature in the second heat exchanger or alternatively in conduits fluidly connected to the outlet of the second heat exchanger.

During fueling when the cooling system is active (not in standby), the pressure in the second heat exchanger 11 starts rising at some point, when the cooling capacity of the primary cooling loop is exhausted. When the pressure in the second heat exchanger 11 exceeds a primary operation parameter threshold, which in this exemplified embodiment is a primary pressure threshold of 8.3 bar (corresponding to approximately minus 45 degrees Celsius), the pressure regulated buffer valve 16, which is regulated via communication line 22b connected to the pressure sensor 21a, opens, and a buffer flow comprising a portion of the gaseous refrigerant from the second heat exchanger 11 flows via the outlet of the second heat exchanger and the buffer conduit 15 into the solid phase tank 13, where it condenses. As previously described, this reduces the pressure in the second heat exchanger, and thereby reduces the load on the compressor 10, which is thereby able to maintain a temperature below approximately minus 45 degrees Celsius in the second heat exchanger 11, and thereby the hydrogen flow can be cooled sufficiently, e.g. preferably to a temperature that does not e.g. exceed minus 30 degrees Celsius. By utilizing the cooling bank as described, the cooling system is able to maintain the temperature in the second heat exchanger at a higher refueling rate. Without the cooling capacity provided by opening the buffer conduit to the cooling bank (solid phase tank comprising solid phase refrigerant), the fueling rate would need to be reduced in order to achieve sufficient cooling of the hydrogen flow.

Optionally, the buffer valve may be closes when the temperature in the second heat exchanger falls below substantially minus 50 degrees Celsius. Advantageously, this may save cooling capacity of the solid phase tank for later use, when the temperature in the second heat exchanger has fallen to a level at which the primary cooling loop including the second heat exchanger is able to sufficiently cool the hydrogen without using the cooling bank. In an alternative embodiment of the invention, the buffer valve may close when the temperature of refrigerant comprised by the second heat exchanger falls below the saturation temperature of the refrigerant. Advantageously, when this happens, much less of the refrigerant in the second heat exchanger vaporizes and some gaseous refrigerant may condense, and thereby the pressure in the second heat exchanger decreases and the load on the compressor decreases. Optionally, the buffer vale may close when the temperature in the second heat exchanger falls 0 to 15 percent below the saturation temperature, such as falls 0 to 10 percent below the saturation temperature, such as between 0 to 5 percent below the saturation temperature. Thereby, the cooling bank may advantageously be utilized to various degrees before the buffer valve is closed, depending on the implementation of the invention.

When the fueling is terminated, some of the refrigerant in a solid phase 14 comprised by the solid phase tank 13 has been melted by the refrigerant that has entered from the second heat exchanger 11, and some refrigerant previously comprised by the primary cooling loop 8 is also now located in the solid phase tank. To reestablish the distribution of refrigerant among the solid phase tank 13 and the primary cooling loop 8, the buffer filling valve 23 is opened. This enables refrigerant in a liquid phase to level out between the solid phase tank and the second heat exchanger. The two tanks may be positioned at the same level with respect to the ground, to achieve this leveling.

To reestablish the cooling bank of solid phase refrigerant 14 in the solid phase tank, 13, the controller 17 opens the bypass valve 19, the second heat exchanger outlet valve 20 and the buffer filling valve 23 and keeps the compressor 10 active, while the pressure regulated buffer valve 16 is closed. Thereby a buffer buildup flow is established via the bypass conduit 18 to the inlet of the compressor 10, in turn, reducing pressure in the solid phase tank and thereby lowering the temperature in the tank and so the cooling bank of solid phase refrigerant is reestablished. The bypass valve 19 is closed when the pressure in the solid phase tank reaches the buffer operation parameter threshold, which in this embodiment is a pressure (buffer pressure) of approximately 5.2 bar, measured in the solid phase tank with the sensor 21b. Other embodiments may utilize a different pressure as buffer operation parameter threshold. This threshold depends on the properties of the refrigerant used by the cooling system, and so, using refrigerants with different properties such as different triple points different may require a different buffer operation parameter threshold. It may, e.g. be advantageous to utilize a pressure and/or temperature corresponding to the triple point of the refrigerant to determine when to terminate the buffer buildup flow, e.g. by closing the bypass valve 19. E.g. terminating the buffer buildup flow when the pressure and/or temperature falls below the pressure and/or temperature corresponding to the triple point of the refrigerant.

Optionally, the buffer valve 16 may be controlled by the controller 17. E.g. the buffer valve may be implemented as an electrically regulated on/off valve.

Optionally, the cooling system may comprise temperature sensors configured to measure temperature in the solid phase tank and/or in the second heat exchanger. The buffer buildup flow and the buffer flow may thereby be controlled based temperature measurements, measured by temperature sensors and further based on temperature thresholds, as opposed to the pressure thresholds described above. Alternatively, the buffer build up flow and/or the buffer flow may be controlled according to both pressure and temperature measurements.

Optionally, the rpm of the compressor 10 and/or the state of the valves comprised by the cooling system may be regulated according to temperature measurements of the second heat exchanger 11 and/or temperature measurements of the solid phase tank 13.

Optionally, the inlet at the bottom of the second heat exchanger 11 may comprise a second heat exchanger inlet valve. Advantageously this enable active filling of the solid phase tank with refrigerant from the second heat exchanger. In this optional configuration, to redistributed refrigerant to the solid phase tank, the compressor is activated and this second heat exchanger inlet valve, the buffer valve 16 and the bypass valve 19 is closed, while the buffer filling valve 23 and the second heat exchanger outlet valve is in an open state. Further optionally, the solid phase tank may comprise level measuring means of measuring the amount of refrigerant in the solid phase tank, and thereby the filling of the solid phase tank may advantageously be terminated when the solid phase tank comprises a sufficient amount of refrigerant as measured by the level measuring means.

Optionally, the buffer operation parameter may be a temperature measured in the solid phase tank by a temperature sensor, and the buffer operation parameter threshold may be a temperature value. In an exemplified embodiment of the invention, the buffer operation parameter threshold may be substantially minus 56.5 degrees Celsius.

Optionally, the primary operation parameter is a temperature measured in the second heat exchanger, and the primary operation parameter threshold is a temperature value.

FIG. 4 illustrates a schematic view of a cooling system with a condensate boiler and a solid phase tank comprising a condensation structure in form of a coil (it should be understood that the coil may sometimes be referred to as a coil conduit), according to an embodiment of the invention. The cooling system illustrated in FIG. 4 may be considered a variation of the previously described cooling system illustrated in FIG. 1 to FIG. 3. As such, additional features illustrated in FIG. 4 may be implemented with any other embodiments of the invention.

In addition to the previous embodiments of the cooling system of the hydrogen refueling station, the cooling system of FIG. 4 comprises a buffer conduit 15 with a condensate boiler 28. The buffer conduit 15 enters the solid phase tank 13 from the bottom of the tank, where it fluidly connects with a coil 27 (coil conduit) that extends upwards through the solid phase tank 13 with its outlet positioned above the refrigerant in a solid phase 14 comprised by the solid phase tank 13. When the buffer valve 16 is opened to utilize the solid phase refrigerant 14 of the solid phase tank 13 for cooling, gaseous refrigerant from the second heat exchanger enters the solid phase tank via the buffer conduit 15 at the bottom of the tank into the coil 27 where it condenses and is exhausted in the top into the vessel as a mixture of gas and liquid. The condensation energy is taken by melting the ice (solid phase refrigerant 14) on the other side of the refrigerant. Thereby the refrigerant entering the coil 27 from the second heat exchanger is cooled. When refrigerant condenses in the coil, some excess liquid may build up in the coil as the pressure in the coil decreases, e.g. when a fueling is terminated and the flow of hydrogen to be cooled stops. This liquid may transform into ice during the process of restoring the cooling bank of solid phase refrigerant 14 in the solid phase tank 13 as previously described. To avoid blockage of the coil with icy refrigerant, the condensate boiler 28, which is essentially a vessel with a boiler, collects the condensed refrigerant, and boils it off when enough condensate has been collected. During the boil off process, the buffer valve 16 is closed and the boiloff refrigerant is led back to the second heat exchanger 11.

Optionally, the embodiment of FIG. 4 may be implemented without the condensate boiler. In this configuration, the embodiment would be similar to the embodiment of FIG. 3, although with the buffer conduit 15 connecting with the coil 27 in the solid phase tank 13. In this embodiment of the invention, the solid phase tank 13 may be positioned above the second heat exchanger 11 to enable refrigerant that condensate inside the coil to flow back into the second heat exchanger, utilizing the force of gravity.

Optionally, the condensate boiler may be implemented in any other disclosed embodiments of the invention. This means that the condensate boiler e.g. may also be implemented in embodiments not comprising the coil 27 illustrated in FIG. 4.

It should be understood that while this particular embodiment illustrates a coil, the coil could optionally in principle take a different shape. The shape may be preferably be optimized to provide a large contact surface between the coil and the surrounding refrigerant in a solid phase 14 to provide efficient cooling of refrigerant inside flowing inside the coil. Also, the buffer conduit 16 may be split into more than one coil element, such as e.g. two, three, four or more elements with the same shape or with different shapes.

FIG. 5 illustrates a schematic view of a cooling system of a hydrogen refueling station (not shown) with a dehumidification conduit according to an embodiment of the invention. The cooling system illustrated in FIG. 5 may be considered a variation of previously described exemplified cooling systems of the invention. The cooling system is, for example, arranged similar to the embodiment illustrated in FIG. 4, although with the difference that instead of the condensate boiler illustrated in FIG. 4, a dehumidification conduit 24 with a dehumidification valve 25 is arranged to establish a fluid connection form the outlet of the compressor to the condensation structure, which in this embodiment is a coil 27.

The dehumidification valve 25 is controlled by the controller 17. When the dehumidification valve 25 is opened by the controller and the buffer valve 16 is closed, hot gaseous refrigerant is led from the compressor outlet into the coil 27 of the cooling bank, via the dehumidification conduit 24, and thereby the hot refrigerant removes potential liquid present inside the coil. This step may be, e.g., performed after a refueling process, when the cooling bank (solid phase tank comprising soli phase refrigerant) has been used, to reduce the risk of refrigerant ice formation inside the coil. During the process, the second heat exchanger valve 20 is kept open to enable refrigerant to flow from the second heat exchanger 11 to the inlet of the compressor 10. Furthermore, the expansion valve is preferably closed, to hinder refrigerant from circulating in the primary cooling loop, during the dehumidification process.

The dehumidification conduit 24 and the dehumidification valve 25 may optionally be implemented in any of the other described embodiments of the invention.

Optionally, the opening and closing of the dehumidification valve 25 may be based on temperature and/or pressure measurements and/or based on whether the refueling system of the hydrogen refueling station is fueling. These measurements may be measured in any one or more of the components of the cooling system.

It should be understood that the coil 27 may sometimes be referred to as a coil conduit.

FIG. 6 illustrates a schematic view of a cooling system with a receiver vessel and a compartmentalized solid phase tank according to an embodiment of the invention. The cooling system may be considered a variation of any one or more of the previously described exemplified cooling systems of the invention, but further comprising a drainage conduit 30 with a drainage valve 31 and with a receiver vessel 32 and a receiver vessel outlet valve 33. Further added is a compartmentalized solid phase tank 13, additional sensors 21c-e, and a three-way valve controlling the distribution of the refrigerant downstream the first heat exchanger 9.

In greater detail, the cooling system illustrated in FIG. 6 comprised a primary cooling loop with a second heat exchanger outlet valve 20, a first heat exchanger 9, an expansion valve 26, a three-way valve 34. The primary cooling loop further comprises sensors 21a, 21d and 21e configured to measure a fluid parameter associated with the second heat exchanger 11, with the conduit connecting the outlet of the compressor 10 to the first heat exchanger 9, and with the outlet of the first heat exchanger 9, respectively. In this embodiment, the illustrated senor 21d represents two sensors, namely a pressure sensor and a temperature sensor configured to measure the pressure and temperature in the conduit connected to the compressor outlet, and the sensor 21e is a temperature sensor configured to measure the temperature of the refrigerant downstream the first heat exchanger. This enables monitoring of the pressure of the refrigerant that enters the first heat exchanger, and at the same time it enables monitoring of the cooling provided by the first heat exchanger, based on the difference in temperature measured with the two sensors 21d and 21e. The sensor 21a represents a sensor configured to measure a primary operation parameter associated with the second heat exchanger 11. More particular, the illustrated sensor 21a represents a temperature sensor configured to measure a temperature (primary temperature) of refrigerant comprised by the second heat exchanger 11, and a pressure sensor configured to measure pressure (primary pressure) in the second heat exchanger 11. The sensors is utilized by the controller 17 to regulate the compressor 10 and the expansion valve 26. Further based on this sensor 21a, the primary temperature and the primary pressure can be monitored in the second heat exchanger, and as previously described, the buffer flow and buffer buildup flow can thus be established based on these primary temperature and primary pressure readings and associated primary operation parameter threshold and buffer operation parameter threshold.

The cooling system comprises further components also included in other exemplified embodiments of the invention. Namely, a solid phase tank 13 comprising refrigerant in a solid phase 14, a buffer conduit 15 with a buffer valve 16, a bypass conduit 18 with a bypass valve 19, a buffer filling conduit 29 and the controller 17.

As described in relation to other exemplified embodiments of the invention, the cooling bank of solid phase refrigerant comprised by the solid phase tank 13 is generated or regenerated (refrigerant is solidified) e.g. when the cooling system is not cooling, by establishing the buffer buildup flow via the bypass conduit 18, by opening the bypass valve 19, which in this embodiment is a one-way valve, meaning that the refrigerant can only flow through the valve coming from the solid phase tank 13 and towards the inlet of the compressor 10. To utilize the cooling bank when the cooling capacity of the second heat exchanger is exhausted, the buffer flow is established via the buffer conduit 15 by opening the buffer valve 16, as previously described. If the amount of refrigerant in the solid phase tank becomes low, e.g. as a result of melted refrigerant being collected by the second heat exchanger 11, the buffer filling conduit 29 can be utilized for filling the solid phase tank 13 with refrigerant from the second heat exchanger 11. In this embodiment, the second heat exchanger is a tank (also referred to as liquid phase tank) comprising refrigerant in a liquid phase, and some boiloff gaseous refrigerant. The cooling system utilizes carbon dioxide as refrigerant.

At standby, where the cooling bank in the solid phase tank 13 is established, and a the fueling status is off, meaning that no fueling is performed by the refueling system (not shown) of the hydrogen refueling station (not shown), the second heat exchanger outlet valve 20 and the drainage valve 31 is open, while the buffer valve 16, the bypass valve 19 and the receiver vessel outlet valve 33 is closed, and the three-way valve 34 is open towards the second heat exchanger. Thereby liquid refrigerant, e.g. melted solid phase refrigerant, in the solid phase tank 13 may be collected by the receiver vessel via the drainage conduit 30.

When fueling starts, the compressor 10 is activated and the expansion valve 26 regulates to maintain a given subcooling of the refrigerant after the first heat exchanger 9. The compressor regulates after a pressure signal from the pressure sensor 21a. When the pressure in the second heat exchanger 11 (sometimes referred to as primary pressure) exceeds a primary operation parameter threshold, the pressure regulated buffer valve 16 opens and part of the gaseous refrigerant flows from the second heat exchanger 11 via the buffer conduit 15 into solid phase tank 13, where it condenses. The liquid refrigerant is collected in the receiver vessel 32.

When the fueling ends, the flow of hydrogen to be cooled is terminated and the controller receives a fueling status off signal from the refueling system (not shown) and/or directly from e.g. a sensor monitoring a representation of the hydrogen flow or the hydrogen flow (not shown). The compressor is still activated, and thereby cooling of the refrigerant continues, and as the temperature drops, the primary pressure reduces proportionally in the second heat exchanger. When the primary pressure (a primary operation parameter) measured by the sensor 21a falls below a threshold of substantially 6.8 bar (corresponding to a temperature of substantially minus 50 degrees Celsius for carbon dioxide), the second heat exchanger outlet valve 20 and the drainage valve 31 get a signal to close, and at the same time, the three-way valve 34 changes direction to direct the refrigerant toward the solid phase tank via the buffer filling conduit 29. Optionally, a temperature threshold of minus 50 degrees Celsius measured in the second heat exchanger (corresponding to the primary pressure of 6.8 bar) could be used similar to the pressure threshold, in some embodiments of the invention. Notice that the three-way valve makes it possible to omit the buffer filling valve of some other exemplified embodiments of the invention. When the drainage valve 31 is closed, the receiver vessel outlet valve 33 is opened to equalize the pressure between the receiver vessel and the second heat exchanger, and thereby enable the liquid refrigerant condensed in the solid phase tank and collected by the receiver vessel 32, to flow back into the second heat exchanger. In this exemplified embodiment of the invention, the solid phase tank 13 and the liquid receiver is positioned above the second heat exchanger with respect to the ground, and thereby the force of gravity may be utilized for emptying the receiver vessel 32.

Because the second heat exchanger outlet valve 20 is closed, the pressure in the conduits upstream the inlet of the compressor 10, including a portion of the bypass conduit, falls until the bypass valve 19, which in this embodiment is a one-way check valve, opens, as the pressure falls below the pressure in the solid phase tank, e.g. the pressure falls below substantially 5.2 bar. When the bypass valve 19 opens, the compressor 10 removes refrigerant from the solid phase tank 13 and the liquid refrigerant is guided from the first heat exchanger toward the solid phase tank 13 via the buffer filling conduit 29. When the pressure in the solid phase tank 13 falls below the buffer operation parameter threshold, the system returns to standby. Thus, as previously described, in standby, the compressor 10 is inactivated, the three-way valve 34 change direction to guide liquid refrigerant toward the second heat exchanger 11, the second heat exchanger outlet valve 20 and the drainage valve 31 is opened, and the receiver vessel outlet valve 33, the buffer valve 16 and the bypass valve 19 is closed.

Refrigerant received by the solid phase tank 13 from the buffer conduit 15 may condense and thereby if it is not able to pass through the solid phase refrigerant 14, the condensate may quickly fill the solid phase tank and thereby the cooling capacity of the solid phase tank may be reduced. Thus, in this exemplified embodiment of the invention, the solid phase tank 13, comprises a fluid compartment 36 and a solid phase compartment. Advantageously, the fluid compartment enables refrigerant received by the solid phase tank 13 to flow through the fluid compartment 36 towards the bottom of the solid phase tank to be led back to the second heat exchanger and/or optionally it may e.g. be collected by the receiver vessel 32 beforehand. The fluid compartment 36 is thermally connected to a solid phase compartment comprising the solid phase refrigerant 14 so that the solid phase refrigerant may efficiently cool refrigerant received in the fluid compartment. In this embodiment, the fluid passage compartment is fluidly connected to the buffer conduit 15 and to the bypass conduit 18. On the other hand, the solid phase compartment is fluidly connected to the buffer filling conduit 29. The two compartments are connected via at least one compartment passage 37, which propagate from a bottom portion of the fluid compartment and upwards to connect with an upper portion of the solid phase compartment. The arrangement of the compartment passage ensures that condensed refrigerant may not flow into the solid phase compartment by e.g. the force of gravity, while at the same time, it ensures that the pressure drop in the fluid compartment produced when refrigerant is evacuated via the bypass line also affects the solid phase compartment. Furthermore, this arrangement advantageously ensures that the solid phase compartment may be filled with refrigerant from the second heat exchanger via the buffer filling conduit 29, when required. At the same time, the establishment of the solid phase compartment may be performed by reducing pressure by evacuating e.g. gaseous refrigerant via the bypass line connected to the fluid compartment.

The fluid compartment 37 comprises condensation structures 38. In this exemplified embodiment, the condensation structures 38 connects an upper portion of the fluid compartment 37 with a lower portion of the fluid compartment 37. The exterior portion of the condensation structures 38 is partly enclosed by solid phase refrigerant 14. The condensation structures enable hot refrigerant received from the second heat exchanger to be efficiently cooled via the thermal connection to the solid phase refrigerant 14. The embodiment in FIG. 6 illustrates only five parallelly arranged condensation structures for illustration purpose, however, different implementation may comprise a much larger amount of condensation structures to substantially increase the total contact surface area between the condensation structures 38 and the solid phase refrigerant, as this may increase the heat transition from the refrigerant comprised by the condensation structures and the solid phase compartment. The condensation structures may be implemented to improve the mentioned heat transfer by utilizing different designs, such as, coil shapes, plates, wave pattern etc.

Optionally, the solid phase tank may comprise level measurement means to measure a fluid level, such as a refrigerant level, in the solid phase tank. Level measuring means may e.g. comprise a load cell to measure the mass of the refrigerant or the solid phase tank, a scale to measure the volume or height of the refrigerant, e.g. a ruler configured to measure the level of refrigerant in the tank. Other level measuring means may be utilized depending on the implementation of the invention, as previously described. When the refrigerant level such as e.g. the mass of the refrigerant in the solid phase tank falls below a refrigerant level threshold, refrigerant is redistributed to the solid phase tank 13 from the second heat exchanger 11. Refilling of the solid phase tank 13 may be performed by injecting refrigerant from the second heat exchanger 11 into the solid phase tank 13 by opening the second heat exchanger outlet valve 20 and by setting the three-way valve 33 to guide refrigerant from the first heat exchanger 9 via the buffer filling conduit 29 towards the solid phase tank 13. The redistribution of refrigerant to the solid phase tank 13 is performed until a refrigerant level threshold is reached.

Optionally, when the amount of refrigerant in the solid phase tank is too large, e.g. the fluid level is too high and/or the mass is to heavy, the compressor 10 is activated, the second heat exchanger outlet valve 20 is closed and the three-way valve 34 is set to lead refrigerant towards the second heat exchanger 11, so that refrigerant from the solid phase tank 13 is evacuated via the bypass conduit 18 and into the second heat exchanger via the three-way valve 33, when the pressure falls below the threshold at which the bypass valve opens, which could e.g. be when the pressure in the conduits between the inlet of the compressor 10 and the bypass valve falls below the pressure in the solid phase tank, e.g. at a pressure below 5.2 bar. The redistribution of refrigerant to the second heat exchanger 11 is performed until a refrigerant level threshold is reached. The refrigerant level threshold depends on the implementation of the invention, including e.g. the size of the cooling system, which will vary according to the cooling requirements of the hydrogen refueling station.

Notice that the previously described functionality of the buffer filling valve illustrated on FIG. 3, FIG. 4 and FIG. 5 is implemented in the three-way valve 33. Thereby, the three-way valve may also be implemented with any other exemplified embodiment of the invention. Furthermore, the features of the embodiment illustrated in FIG. 6 is not limited to be implemented with the three-way valve, but can be implemented with any other embodiment of the invention depending on the implementation of the invention.

Relevant to any embodiments of the invention, optionally, a hydrogen cooling loop may be implemented in any embodiments of the invention. Thus, optionally, the supply conduit may comprise a hydrogen cooling loop comprising a hydrogen cooling loop inlet valve and a hydrogen cooling loop outlet valve, and wherein a portion of the cooling loop is thermally coupled to the solid phase tank. Thereby the hydrogen may, advantageously, be cooled directly by a thermal connection to the solid phase refrigerant comprised by the solid phase tank via the hydrogen cooling loop. The cooling loop may be arranged before or after the second heat exchanger, depending on the implementation of the invention.

FIG. 7 illustrates method steps according to an embodiment of the invention. The method concerns cooling of a hydrogen flow of a refueling system of a hydrogen refueling station comprising a cooling system including a primary cooling loop, which comprises a refrigerant, a first heat exchanger, a compressor, and a second heat exchanger that is thermally coupled to the hydrogen flow comprised by the refueling system. The cooling system further comprises a solid phase tank that comprises the refrigerant.

In a first step (S1) of the method, a cooling bank comprising refrigerant in a solid phase is established by facilitating a phase change of the refrigerant comprised by the solid phase tank into solid phase refrigerant.

In a further step (S2) of the method, the hydrogen flow is established from a hydrogen storage of the refueling system to a vessel of a vehicle via a dispensing module of the refueling system.

In a further step (S3) of the method, the hydrogen flow is cooled via the second heat exchanger by circulating the refrigerant within said primary cooling loop by activating the compressor.

In an additional step (S4) of the method, a buffer flow of refrigerant is established from the primary cooling loop to the solid phase tank via a buffer conduit when a buffer condition is established, to increase a cooling capacity of said second heat exchanger.

In an optional step of the method the hydrogen flow may be redirected from a supply conduit comprising the hydrogen flow to a hydrogen cooling loop via a hydrogen cooling loop inlet valve and back to the supply conduit via a hydrogen cooling loop outlet valve, and wherein a portion of said cooling loop is thermally coupled to the solid phase tank. Thereby the hydrogen may, advantageously, be cooled directly by a thermal connection to the solid phase refrigerant comprised by the solid phase tank via the hydrogen cooling loop. The cooling loop may be arranged before or after the second heat exchanger, depending on the implementation of the invention.

FIG. 8 illustrates a schematic view of a cooling system 7, according to a further embodiment of the invention. The cooling system is a variation of the exemplified cooling system illustrated in FIG. 1, and as such, it comprises the same components. The components include a controller 17, primary cooling loop 8 comprising a compressor 10 connected to a first heat exchanger having an outlet that is connected to a second heat exchanger 11 comprising refrigerant in a liquid phase 12, a buffer conduit 15 with a buffer valve 16 and fluidly connecting the second heat exchanger 11 with a solid phase tank 13 comprising refrigerant in a solid phase 14. Notice however that the buffer conduit 15 of the cooling system illustrated in FIG. 8 is fluidly connected to a lower portion of the solid phase tank 13, while in the exemplified cooling system illustrated in FIG. 1, the buffer conduit is fluidly connected to the upper portion of the solid phase tank. Connecting the buffer conduit 15 to the lower portion of the solid phase tank has the advantage that gas from the second heat exchanger may enter directly into the refrigerant in a solid phase via the buffer conduit 15, when the buffer valve 16 is opened. Advantageously, this may provide a more effective cooling and/or condensation of the gas entering the solid phase tank 13. Furthermore, this may thus advantageously provide an improved efficiency of the cooling system.

Notice that the illustrated configuration wherein the buffer conduit 16 fluidly connects with a lower portion of the solid phase 13 may be applied in any other embodiments of the invention, including, e.g., the embodiments illustrated in FIG. 2-FIG. 6. Moreover, it should be understood that the buffer conduit may optionally be fluidly connecting with other portions of the solid phase tank. These includes at the bottom of the solid phase tank, anywhere on the side of the tank, at the top of the tank, to name a few non-limitational examples.

Similar to other embodiments of the invention, including, e.g., the embodiment illustrated in FIG. 1, the cooling system illustrated in FIG. 8 is configured to cool a flow of hydrogen that flows via a supply conduit 6. The hydrogen flow in the supply conduit 6 may be supplied from a hydrogen storage (not illustrated) and the conduit may, e.g., supply a dispensing module (not illustrated) of a hydrogen refueling station. Thereby, the cooling system of FIG. 8 may provide capabilities similar to those of the embodied cooling system of FIG. 1

FIG. 9 illustrates a schematical view of a cooling system with a bypass conduit 18, a buffer filling conduit 29 and with a buffer conduit 15 fluidly connected to a lower portion of a solid phase tank, according to an embodiment of the invention.

The illustrated cooling system 7 can be considered a variation of previous embodied cooling systems, and is similar to, e.g., the cooling system of FIG. 3, which also comprises a bypass conduit and a buffer conduit. However, the cooling system illustrated in FIG. 9 differs in that the buffer conduit 15 is connected to the lower portion of the solid phase tank 13, instead of to the upper portion. Similar to the embodiment of FIG. 9, this has the advantage that gas from the second heat exchanger may enter directly into the refrigerant in a solid phase via the buffer conduit 15, when the buffer valve 16 is opened. Advantageously, this may provide a more effective cooling and/or condensation of the gas entering the solid phase tank 13. Furthermore, this may thus advantageously provide an improved efficiency of the cooling system. Otherwise, the cooling system of FIG. 9 provides similar functionality to the embodied cooling system of FIG. 3. Hence, description of the cooling system of FIG. 3, including the functioning and control, may also apply to the cooling system illustrated in FIG. 9.

### LIST OF REFERENCE SIGNS

1 Hydrogen refueling station
2 Vessel
3 Vehicle
4 Hydrogen storage
5 Dispensing module
6 Supply conduit
7 Cooling system
8 Primary cooling loop
9 First heat exchanger
10 Compressor
11 Second heat exchanger
12 Refrigerant in a liquid phase
13 Solid phase tank
14 Refrigerant in a solid phase
15 Buffer conduit
16 Buffer valve
17 Controller
18 Bypass conduit
19 Bypass valve
20 Second heat exchanger outlet valve
21a-b Sensor
22a-b Data communication link
23 Buffer filling valve
24 Dehumidification conduit
25 Dehumidification valve
26 Expansion valve
27 Coil conduit/coil
28 Condensate boiler
29 Buffer filling conduit
30 Drainage conduit
31 Drainage valve
32 Receiver vessel
33 Receiver vessel outlet valve
34 Three-way valve
36 Fluid passage compartment
37 Solid phase compartment
38 Condensation structures
S1-S4 Method steps

1.-42. (canceled)

43. A hydrogen refueling station configured to fill a vessel of a vehicle with hydrogen; the hydrogen refueling station comprising:
a refueling system comprising:
a hydrogen storage; and
a dispensing module fluidly connected to said hydrogen storage via a supply conduit and fluidly connectable to said vessel of said vehicle so as to establish a hydrogen flow from said hydrogen storage to said vessel of said vehicle;
wherein said hydrogen refueling station further comprises a cooling system configured to cool said hydrogen flow, wherein said cooling system comprises:
a primary cooling loop comprising: a refrigerant in a liquid phase, a first heat exchanger; a compressor; and a second heat exchanger thermally coupled to said hydrogen flow;
a solid phase tank comprising a refrigerant in a solid phase, and wherein said solid phase tank is fluidly connectable to said primary cooling loop via a buffer conduit comprising a buffer valve; and
a controller configured to control a cooling of said hydrogen flow via said second heat exchanger by controlling a flow of said refrigerant in said primary cooling loop and further configured to increase a cooling capacity of said second heat exchanger by controlling a state of said buffer valve.

44. The hydrogen refueling station according to claim 43, wherein said state of said buffer valve is controlled between an open state and a closed state; and wherein a buffer flow of refrigerant to said solid phase tank from said second heat exchanger is established via said buffer conduit by opening said buffer valve.

45. The hydrogen refueling station according to claim 43, wherein said second heat exchanger includes a liquid phase tank comprising said refrigerant in a liquid phase.

46. The hydrogen refueling station according to claim 43, wherein a buffer flow of refrigerant to said solid phase tank from said second heat exchanger is established when a primary operation parameter of said primary cooling loop exceeds a primary operation parameter threshold.

47. The hydrogen refueling station according to claim 46 wherein said primary operation parameter threshold comprises a predefined primary temperature and/or a predefined primary pressure, and wherein said primary operation parameter comprises a primary temperature established by a primary temperature sensor comprised by said primary cooling loop and/or comprises a primary pressure established by a primary pressure sensor comprised by said primary cooling loop.

48. The hydrogen refueling station according to claim 47, wherein said primary pressure and/or said primary temperature is measured in said second heat exchanger.

49. The hydrogen refueling station according to claim 46, wherein said primary operation parameter threshold includes a temperature between minus 55 degrees Celsius and minus 31 degrees Celsius, such as between minus 52 degrees Celsius and minus 33 degrees Celsius, such as between minus 49 degrees Celsius and minus 35 degrees Celsius, such as between minus 50 degrees Celsius and minus 38 degrees Celsius such as preferably between minus 50 degrees Celsius and minus 40 degrees Celsius, such as preferably a temperature corresponding to a saturation temperature of said refrigerant and/or a temperature above said saturation temperature of said refrigerant.

50. The hydrogen refueling station according to claim 46, wherein a buffer flow of refrigerant to said solid phase tank from said second heat exchanger is terminated when a buffer operation parameter exceeds a buffer operation parameter threshold of said solid phase tank and/or when said hydrogen flow is terminated and/or when said primary operation parameter threshold does not exceed said primary operation parameter threshold.

51. The hydrogen refueling station according to claim 43, wherein a buffer buildup flow of refrigerant from said solid phase tank to an inlet of said compressor is established based on a buffer operation parameter of said solid phase tank and further based on a buffer operation parameter threshold, and wherein said buffer buildup flow facilitates establishment of a cooling bank of said refrigerant in a solid phase comprised by said solid phase tank; and wherein said buffer operation parameter threshold comprises a predefined buffer temperature and/or predefined buffer pressure, and wherein said buffer operation parameter comprises a buffer temperature established by a buffer temperature sensor configured to measure a temperature of said solid phase tank and/or comprises a buffer pressure established by a pressure sensor configured to measure a pressure of said solid phase tank.

52. The hydrogen refueling station according to claim 43, wherein a second heat exchanger outlet valve is arranged at an outlet of said second heat exchanger.

53. The hydrogen refueling station according to claim 43, wherein said solid phase tank is fluidly connected to an inlet of said compressor via a bypass conduit comprising a bypass valve, and wherein said bypass conduit is arranged to bypass said second heat exchanger.

54. The hydrogen refueling station according to claim 43, wherein a buffer buildup flow of refrigerant from said solid phase tank to an inlet of said compressor is established via a bypass conduit arranged to bypass said buffer conduit, and wherein said buffer buildup flow is established by opening a bypass valve comprised by said bypass conduit.

55. The hydrogen refueling station according to claim 43, wherein in a no fueling state of said hydrogen refueling station the controller controls an operation pressure in said solid phase tank to be lower than an operation pressure in said second heat exchanger, by controlling a buffer buildup flow and by controlling said compressor.

56. The hydrogen refueling station according to claim 43, wherein said refrigerant in a liquid phase and said refrigerant in a solid phase is carbon dioxide.

57. The hydrogen refueling station according to claim 43, wherein said cooling system comprises a buffer filling conduit with a buffer filling valve, wherein said buffer filling conduit is fluidly connecting an outlet of said compressor with said solid phase tank.

58. The hydrogen refueling station according to claim 43, wherein said solid phase tank is fluidly connected to said second heat exchanger via a drainage conduit comprising a drainage valve.

59. The hydrogen refueling station according to claim 58, wherein said drainage conduit comprises a receiver vessel and a receiver vessel outlet valve positioned downstream said receiver vessel, and wherein said receiver vessel is positioned downstream said drainage valve.

60. The hydrogen refueling station according to claim 43, wherein said solid phase tank comprises:
a solid phase compartment at least partly filled with solid phase refrigerant, and
a fluid passage compartment;
wherein said fluid passage compartment comprises an inlet fluidly connected to said buffer conduit, and wherein said solid phase compartment comprises an inlet connected to an outlet of said compressor, and wherein said solid phase compartment and said fluid passage compartment is at least thermally connected.

61. The hydrogen refueling station according to claim 60, wherein said fluid passage compartment comprises a plurality of condensation structures having an exterior portion at least partly enclosed by solid phase refrigerant, and an interior portion configured to receive refrigerant from said buffer conduit.

62. A method of cooling a hydrogen flow of a refueling system of a hydrogen refueling station, wherein said hydrogen refueling station comprises a cooling system comprising:
a primary cooling loop comprising a refrigerant; a first heat exchanger, a compressor, and a second heat exchanger thermally coupled to said hydrogen flow comprised by said refueling system; and
a solid phase tank comprising said refrigerant;
wherein said method comprises the steps of:
establishing a cooling bank comprising refrigerant in a solid phase by facilitating a phase change of said refrigerant comprised by said solid phase tank into solid phase refrigerant;
establishing said hydrogen flow from a hydrogen storage of said refueling system to a vessel of a vehicle via a dispensing module of said refueling system;
cooling said hydrogen flow via said second heat exchanger by circulating said refrigerant within said primary cooling loop by activating said compressor;
establishing a buffer flow of refrigerant from said primary cooling loop to said solid phase tank via a buffer conduit when a buffer condition is established, to increase a cooling capacity of said second heat exchanger.
